(19) United States
(12) Patent Application Publication
(10) Pub. No.: US 2013/0176324 A1
(43) Pub. Date: Jul. 11, 2013

(54) DISPLAY DEVICE, ELECTRONIC APPARATUS, DISPLAYING METHOD, AND PROGRAM

(71) Applicant: Sony Corporation, Tokyo (JP)

(72) Inventors: Junichi Yamashita, Tokyo (JP); Katsuhide Uchino, Kanagawa (JP); Takashi Uchida, Kanagawa (JP); Yuki Seo, Kanagawa (JP); Kazuhiko Ueda, Kanagawa (JP); Masuyoshi Kurokawa, Kanagawa (JP)

(73) Assignee: Sony Corporation, Tokyo (JP)

(21) Appl. No.: 13/734,004

(22) Filed: Jan. 4, 2013

(30) Foreign Application Priority Data
Jan. 11, 2012 (JP) 2012-002903

(51) Int. Cl. G09G 5/02

(52) U.S. Cl. CPC G09G 5/02
USPC 345/589

(57) ABSTRACT

Disclosed herein is a display device including: a sampling block sampling image data continuously inputted thereto at predetermined intervals; a gradation value/deterioration amount converting block converting a gradation value of an image based on the image data sampled in the sampling block into a deterioration amount; a deterioration amount storing block calculating and accumulating a difference in deterioration amount between a correction object pixel and a reference pixel by using the deterioration amount obtained through the conversion in the gradation value/deterioration amount converting block; a correction amount calculating block calculating a correction amount required for resolving the deterioration amount difference stored in the deterioration amount storing block based on an estimated deterioration amount within a correction period of time; and a deterioration amount difference correcting block correcting the gradation value of the corresponding pixel with the correction amount thus calculated.

### BACKGROUND

The present disclosure relates to a display device, an electronic apparatus, a displaying method, and a program. More particularly, the present disclosure relates to a display device in which a pixel that has been deteriorated by long-term use can be corrected by using a suitable correction value, an electronic apparatus including the same, a displaying method used in the same, and a program used in the same.

Flat panel display devices have become increasingly widespread in the form of products such as a computer display, a personal digital assistance, and a television receiver. At the present time, many liquid crystal display panels are adopted. However, organic EL (electroluminescence) display devices having self-emission elements, and the like are being adopted now.

A self-emission element such as an organic EL element or the like has characteristics of being deteriorated depending on an emission amount and an emission time. Contents of an image which is displayed on a self-emission display device are not uniform. For this reason, deterioration of the self-emission display device is easy to partially progress. For example, luminance deterioration progresses faster in a time display area (fixed display area) than in any other display areas (moving images display area).

A luminance of the self-emission element in which deterioration has progressed is relatively reduced as compared with the case of the luminance of any of other display areas. In general, this phenomenon is called “burn-in.” Hereinafter, partial deterioration of a self-emission element is described as “burn-in.” That is to say, since the emission amount differs every pixel, a deterioration rate differs every pixel, which is visually recognized as the burn-in. At the present time, various kinds of techniques are studied as measures taken to improve the “burn-in” phenomenon. For example, Japanese Patent Laid-Open No. 2000-132139 discloses a technique with which input display data (gradation value) is accumulated, and a correction value corresponding to the accumulated value is read out from a table memory.

### SUMMARY

With the correcting technique described in Japanese Patent Laid-Open No. 2000-132139, for the purpose of carrying out calculation and storage of the accumulated value in real time, a bus width which is twice as wide as a bus width corresponding to a maximum value of the accumulated value is required for reading and writing of data. That is to say, for correcting the deterioration, in order that an accumulated deterioration amount of each pixel is preserved and the correction is carried out by using a suitable correction value for each pixel from the accumulated deterioration amount, thereby preventing the burn-in phenomenon from being visually recognized, a memory is required for preserving data on the accumulated deterioration amount of each pixel. As a result, a large-capacity memory is required.

In addition, for the purpose of sampling a video signal which is changed at a high speed, in addition to the capacity, a wide memory band is required. Since in recent years, panels have grown in size and have been increased in definition, there is required a high processing ability with which the processing can be executed at a high speed, and a wide memory band.

The present disclosure has been made in view of such circumstances, and it is therefore desirable to provide a display device in which a capacity and a band of a memory required for processing for correcting deterioration of a pixel can be reduced, an electronic apparatus including the same, a displaying method used in the same, and a program used in the same.

In order to attain the desire described above, according an embodiment of the present disclosure, there is provided a display device including: a sampling block sampling image data continuously inputted thereto at predetermined intervals; a gradation value/deterioration amount converting block converting a gradation value of an image based on the image data sampled in the sampling block into a deterioration amount; a deterioration amount storing block calculating and storing a difference in deterioration amount between a correction object pixel and a reference pixel by using the deterioration amount obtained through the conversion in the gradation value/deterioration amount converting block; a correction amount calculating block calculating a correction amount required for resolving the deterioration amount difference stored in the deterioration amount storing block based on an estimated deterioration amount within a correction period of time; and a deterioration amount difference correcting block correcting the gradation value of the corresponding pixel with the correction amount thus calculated.

According to another embodiment of the present disclosure, there is provided an electronic apparatus including a display device, the display device including: a sampling block sampling image data continuously inputted thereto at predetermined intervals; a gradation value/deterioration amount converting block converting a gradation value of an image based on the image data sampled in the sampling block into a deterioration amount; a deterioration amount storing block calculating and storing a difference in deterioration amount between a correction object pixel and a reference pixel by using the deterioration amount obtained through the conversion in the gradation value/deterioration amount converting block; a correction amount calculating block calculating a correction amount required for resolving the deterioration amount difference stored in the deterioration amount storing block based on an estimated deterioration amount within a correction period of time; and a deterioration amount difference correcting block correcting the gradation value of the corresponding pixel with the correction amount thus calculated.

According to still another embodiment of the present disclosure, there is provided a displaying method including: sampling image data continuously inputted thereto at predetermined intervals; converting a gradation value of an image based on the image data sampled into a deterioration amount; calculating and storing a difference in deterioration amount between a correction object pixel and a reference pixel by using the deterioration amount obtained through the conversion; calculating a correction amount required for resolving the deterioration amount difference stored based on an estimated deterioration amount within a correction period of time; and correcting the gradation value of the corresponding pixel with the correction amount thus calculated.

According to yet another embodiment of the present disclosure, there is provided a computer-readable program executing processing including: sampling image data continuously inputted thereto at predetermined intervals; converting a gradation value of an image based on the image data sampled into a deterioration amount; calculating and storing a difference in deterioration amount between a correction object pixel and a reference pixel by using the deterioration amount obtained through the conversion; calculating a correction amount required for resolving the deterioration amount difference stored based on an estimated deterioration amount within a correction period of time; and correcting the gradation value of the corresponding pixel with the correction amount thus calculated.

In the display device, the electronic apparatus, the displaying method, and the program according to the embodiment of the present disclosure, the image data continuously inputted is sampled at the predetermined intervals, and the gradation value of the image based on the image data thus sampled is converted into the deterioration amount. Also, the difference in deterioration amount between the correction object pixel and the reference pixel is calculated and stored by using the deterioration amount obtained through the conversion. The correction amount required for resolving the deterioration amount difference thus stored is calculated based on the estimated deterioration amount within the correction period of time, and the gradation value of the corresponding pixel is corrected with the correction amount thus calculated.

As set forth hereinafter, according to the embodiment of the present disclosure, it is possible to reduce the capacity and band of the memory required for the processing adapted to correct the deterioration of the pixel.

### BRIEF DESCRIPTION OF THE DRAWINGS

FIG. 1 is a block diagram showing a schematic configuration of an organic EL display device as a display device to which an embodiment of the present disclosure is applied;

FIG. 2 is a block diagram showing an internal configuration of a burn-in correcting portion in the organic EL display device shown in FIG. 1;

FIG. 3 is a table showing a correction table in which a correspondence relationship between a gradation value and a deterioration rate is held;

FIG. 4 is a graphical representation explaining a principle for processing adapted to correct a burn-in phenomenon;

FIG. 5 is a block diagram showing a bit width for connection among signal processing blocks;

FIG. 6 is a block diagram showing an internal configuration of another burn-in correcting portion in the organic EL display device;

FIGS. 7A and 7B are respectively diagrams explaining a timing of sampling according to a first example of the embodiment of the present disclosure;

FIG. 8 is a block diagram showing an internal configuration of a sampling adjusting block according to the first example of the embodiment of the present disclosure;

FIGS. 9A and 9B are respectively diagrams explaining a timing of sampling according to a second example of the embodiment of the present disclosure;

FIG. 10 is a block diagram showing an internal configuration of a sampling adjusting block according to the second example of the embodiment of the present disclosure;

FIGS. 11A and 11B are respectively diagrams explaining a timing of sampling according to a third example of the embodiment of the present disclosure;

FIGS. 12A and 12B are respectively diagrams explaining a timing of sampling according to a fourth example of the embodiment of the present disclosure;

FIGS. 13A and 13B are diagrams explaining a case where an area of one frame is divided into lattice-like sub-areas according to a fifth example of the embodiment of the present disclosure;

FIG. 14 is a perspective view showing an external appearance of a television set having the display device according to an application example of the present disclosure; and

FIG. 15 is a block diagram showing a configuration of a recording media.

### DETAILED DESCRIPTION OF THE PREFERRED EMBODIMENT

An embodiment of the present disclosure will be described in detail hereinafter with reference to the accompanying drawings.

### [Application to Organic EL Display Device]

Since the present disclosure which will be described below can be applied to a display device and thus can be applied to an organic EL display device as a display device, the present disclosure will be described below by exemplifying the organic EL display device. However, the application of the present disclosure is by no means limited to the organic EL display device, and thus the present disclosure can also be applied to any of display devices other than the organic EL display device.

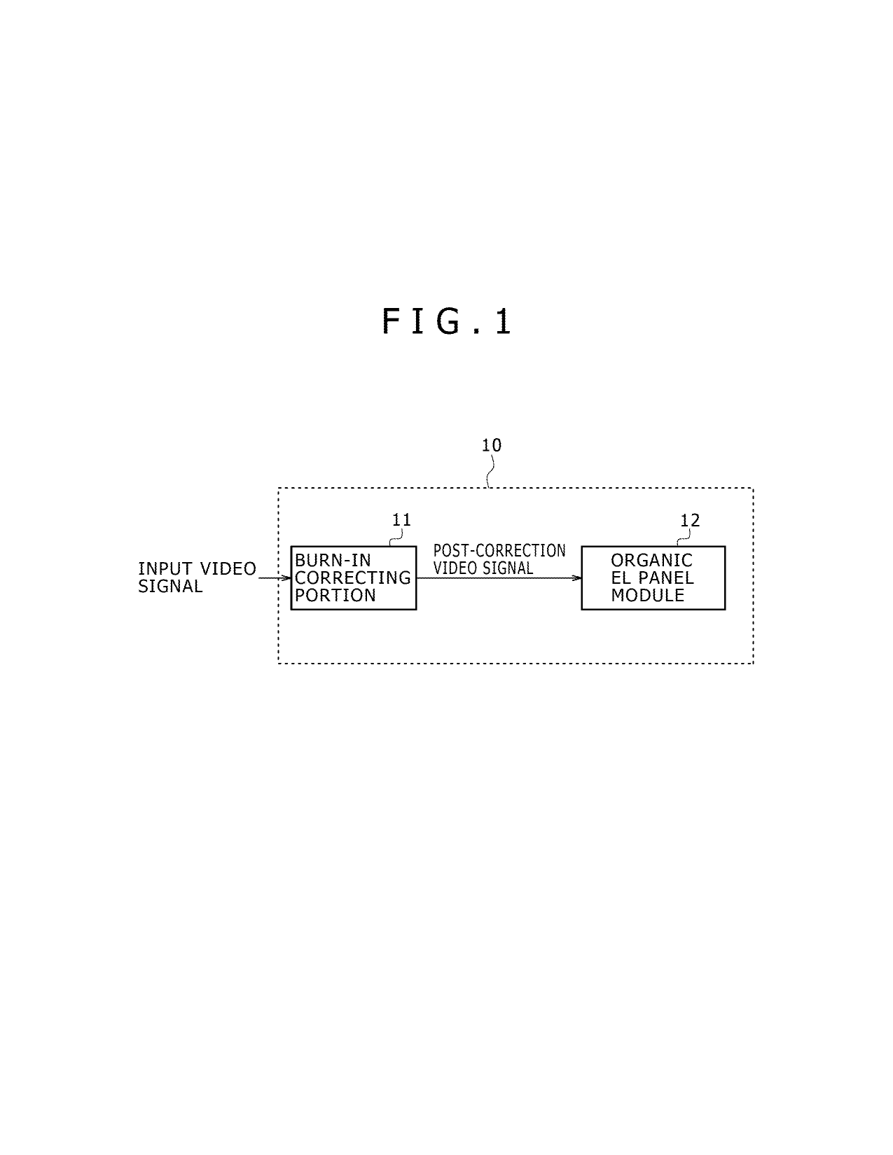

FIG. 1 is a block diagram showing a configuration of an organic EL display device according to the embodiment of the present disclosure. The organic EL display device shown in FIG. 1 is an example of a self-emission display device. An organic EL display device 10 includes a burn-in correcting portion 11 and an organic EL panel module 12. The burn-in correcting portion 11 alternately executes processing for detecting a deterioration amount difference generated between a correction object pixel and a reference pixel, and correction processing for resolving the deterioration amount difference within a correction period of time.

The organic EL panel module 12 is a display device in which an organic EL element is used as a self-emission element. The organic EL panel module 12 includes an effective display area and drive circuits for the effective display area (including a data driver, a scanning driver, and the like). Organic EL elements are disposed in a matrix in the effective display area. It is noted that although a case where emission colors are three colors: red (R); green (G); and blue (B) is described as an example, the embodiment of the present disclosure which will be described below can also be applied to a color(s) other than the three colors. In this case, a description is continuously given on an assumption that one pixel on the display includes the three colors as one set.

### [Basic Configuration of Burn-in Correcting Portion 11]

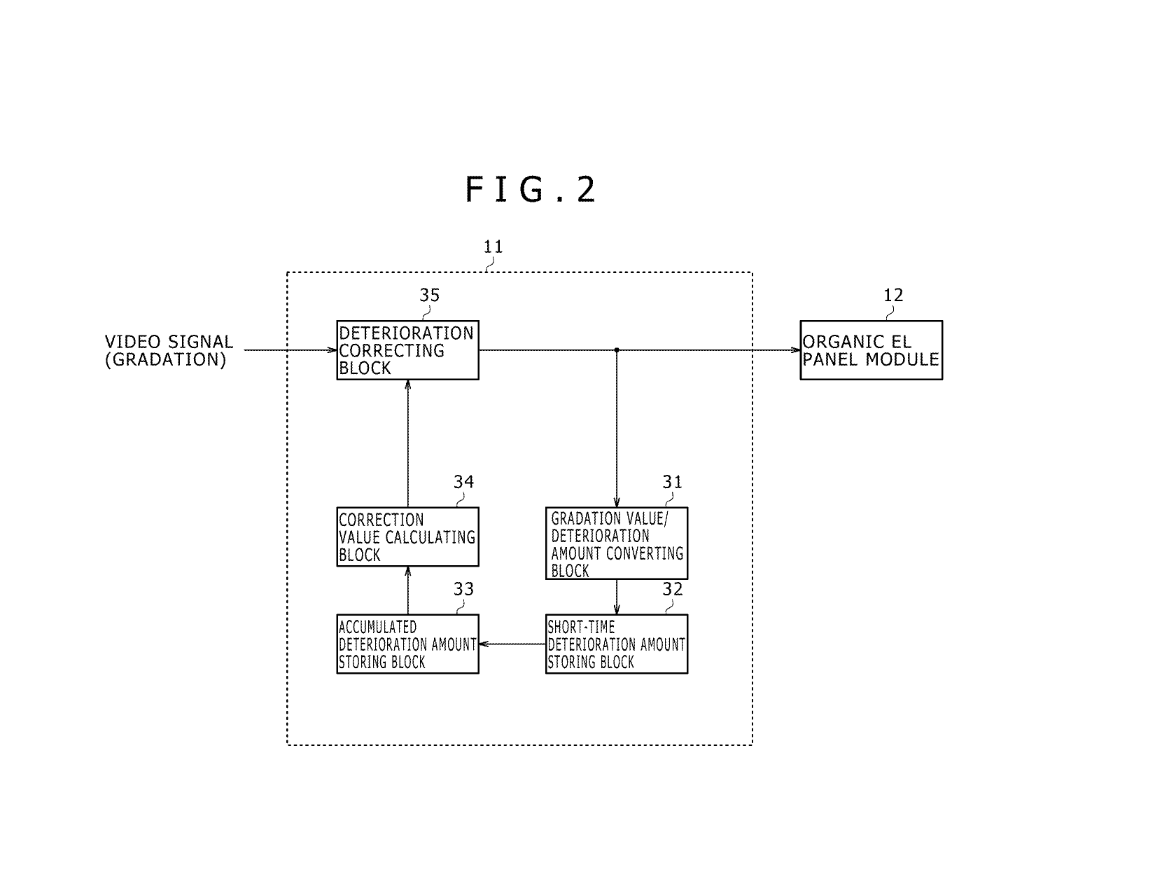

FIG. 2 is a block diagram showing a basic configuration of the burn-in correcting portion 11. The burn-in correcting portion 11 includes a gradation value/deterioration amount converting block 31, a short-time deterioration amount storing block 32, an accumulated deterioration amount storing block 33, a correction value calculating block 34, and a deterioration correcting block 35.

The gradation value/deterioration amount converting block 31 converts a video signal (gradation value) actually supplied to the organic EL panel module 12 into a deterioration amount parameter. The reason why the gradation value is converted into the deterioration amount parameter is because it is corrected that a deterioration amount of the organic EL element is not necessarily proportional to the gradation value. The gradation value/deterioration amount converting block 31 is disposed in order to convert gradation values of pixels (sub-pixels) corresponding to the emission colors, respectively, into deterioration amounts. In the embodiment of the present disclosure, the description is continuously given on an assumption that a relationship between the gradation value, and the deterioration amount of the organic EL element was obtained from experiments, and data on the correspondence relationship is preserved as a list.

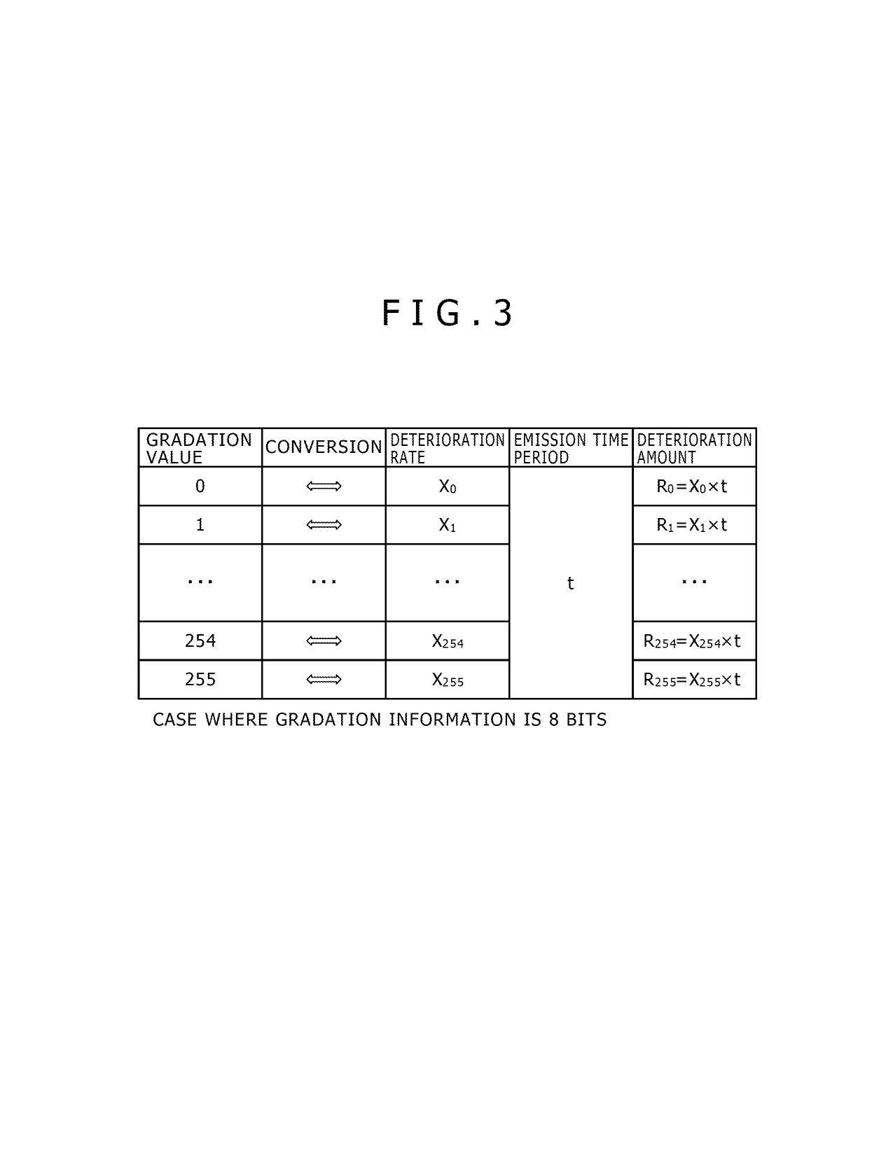

FIG. 3 is a table showing an example of a gradation value/deterioration amount conversion table. In the case of the gradation value/deterioration amount conversion table shown in FIG. 3, the gradation value, a deterioration rate, and the deterioration amount are preserved in the gradation value/deterioration amount conversion table with the gradation value being associated with both of the deterioration rate and the deterioration amount. The deterioration rate means a deterioration amount per unit time. Therefore, the deterioration amount can be obtained by multiplying the deterioration rate by a light emission time t. It is noted that although the description is given by exemplifying the deterioration rate, any of deterioration amount parameters other than the deterioration rate can be used, and thus even when any of deterioration amount parameters other than the deterioration rate is used, the embodiment of the present disclosure which will be described below can be applied thereto.

The short-time deterioration amount storing block 32 calculates a difference in the deterioration amount between each of the pixels (correction object pixels) composing the effective display area, and a reference pixel. Also, the short-time deterioration amount storing block 32 stores therein data on the deterioration amount for a relatively short time. The reference pixel becomes a correction reference in a phase of execution of burn-in correction. A pixel which emits a light with an average gradation value of all of the pixels included in the effective display area is supposed in the embodiment of the present disclosure. The reference pixel may be actually prepared on the display panel or may be virtually prepared by executing signal processing. The short-time deterioration amount storing block 32 subtracts the deterioration amount of the reference pixel from the deterioration amount of the correction object pixel, and calculates the resulting difference value as a deterioration amount difference.

For example, where t1 is a light emission period of time, α1 is the deterioration rate of the correction object pixel, and α2 is the deterioration rate of the reference pixel, a theoretical deterioration amount difference Y can be calculated from Expression (1).

Y=(α1−α2)×t1 (1)

When the theoretical deterioration amount difference Y obtained from Expression (1) is a positive value, this means that the deterioration of the correction object pixel more progresses than that of the reference pixel. On the other hand, when the theoretical deterioration amount difference Y obtained from Expression (1) is a negative value, this means that the deterioration of the correction object pixel is later than that of the reference pixel.

The accumulated deterioration amount storing block 33 preserves an accumulated value of the deterioration amount of the reference pixel, and an accumulated value of the deterioration amount difference of each of the pixels (correction object pixels). For example, a semiconductor memory, a hard disc device, other suitable magnetic storage medium, an optical disc, or other suitable optical storage medium is used as the accumulated deterioration amount storing block 33. The correction value calculating block 34 calculates a correction amount required for resolving the deterioration amount difference calculated every pixel within a correction period of time (future period of time) based on an estimated deterioration amount of the reference pixel.

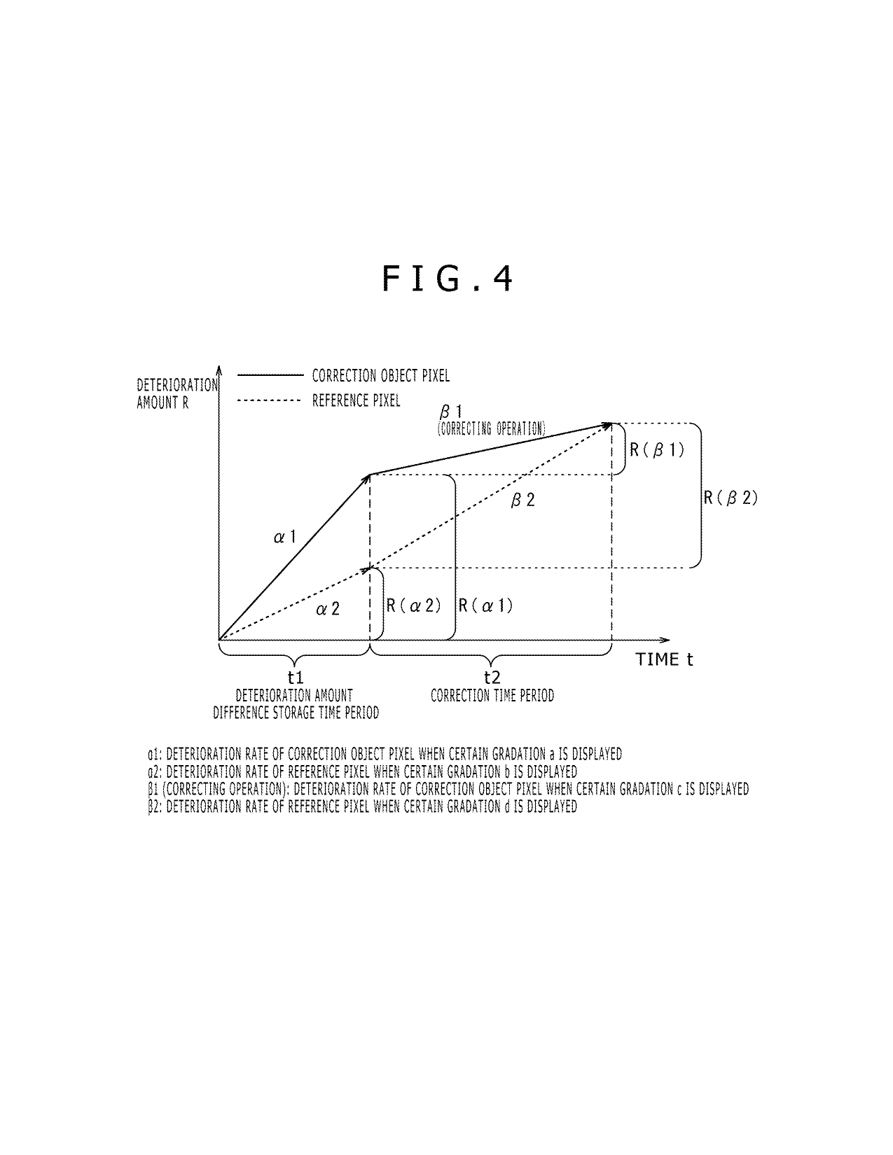

FIG. 4 is a graphical representation representing principles for calculating the correction amount by the correction value calculating block 34. FIG. 4 represents conditions under which the deterioration amount difference generated for a last-minute period, t1, of time (deterioration amount difference storing period of time) is made zero within a correction period, t2, of time. It is noted that in FIG. 4, a transition of the deterioration amount corresponding to the reference pixel is indicated by a broken line, and a transition of the deterioration amount corresponding to the correction object pixel is indicated by a solid line. Where β2 is an estimated deterioration rate of the correction period, t2, of time, an estimated deterioration rate β1 of the correction object pixel is expressed as Expression (2) by using Expression (1) (the deterioration amount difference Y(=(α1−α2)×t1) which is generated for the last-minute period, t1, of time).

β1=β2−Y/t2=β2−(α1−α2)×t1/t2 (2)

The correction value calculating block 34 obtains a gradation value corresponding to the deterioration rate β1 thus calculated by referring to the gradation value/deterioration amount conversion table (refer to FIG. 3). It is noted that this gradation value is one which is obtained in a video signal after the correction. The correction value calculating block 34 subtracts an ideal gradation value (corresponding to β1) from the estimated gradation value of the correction object pixel so as to fulfill this gradation value, and calculates a correction amount corresponding to the correction object pixel.

For example, when the estimated gradation value is larger than the ideal gradation value, the correction value becomes a negative value. When the estimated gradation value is smaller than the ideal gradation value, the correction value becomes a positive value. The deterioration correcting block 35 corrects the gradation value of the corresponding pixel with the correction amount thus calculated. For example, the deterioration correcting block 35 executes processing for adding the gradation value to the input video signal.

It is noted that although in this case, the description is continuously given on an assumption that the correction for such burn-in is carried out, it is also possible that the correction is carried out in such a way that the luminance is aligned, instead of aligning the deterioration amount as described above. Here, let a luminance A be a luminance of a pixel A not deteriorated, let a luminance B be a luminance of a pixel B having a deterioration amount of α1, and let a luminance C be a luminance of a pixel C having a deterioration amount of α2. Note that, it is supposed that a relationship of the deterioration amount α1<the deterioration amount α2 holds. Therefore, the pixel which has been most deteriorated is the pixel C.

In such a case, the correction is carried out such that the luminances of other pixels are aligned with the luminance C of the pixel C which has been most deteriorated. That is to say, the correction is carried out in such a way that the luminance A of the pixel A becomes equal to the luminance C, and the correction is carried out in such a way that the luminance B of the pixel B becomes equal to the luminance C. As a result, each of the luminances of all of the pixels A, B, and C can be made equal to the luminance C. In such a manner, a level of a signal of the pixel not deteriorated may be reduced, whereby the correction may be carried out in such a way that the luminances become equal to one another.

The correction can also be carried out in such a way that the luminances of other pixels are aligned with the luminance A of the pixel A not deteriorated. That is to say, the correction is carried out in such a way that the luminance B of the pixel B becomes equal to the luminance A, and the correction is carried out in such a way that the luminance C of the pixel C becomes equal to the luminance A. As a result, each of the luminances of all of the pixels A, B, and C can be made equal to the luminance A. In such a manner, a level of a signal of the pixel which has been deteriorated may be increased, whereby the correction may be carried out in such a way that the luminances become equal to one another.

When such correction is carried out, as compared with the case of the correction described with reference to FIG. 4, if the deterioration amount becomes clear, the correction can be carried out (the luminances can be aligned with one another) irrespective of the correction period of time. Even when any of the methods of the correction is used, as will be described below, according to the embodiment of the present disclosure, data amount required for carrying out such correction can be suitably reduced. Therefore, the capacity of a memory to be used can be reduced without reducing the correction precision.

It is noted that although in this case, the description is continuously given by exemplifying the configuration in which as shown in FIG. 2, the short-time deterioration amount storing block 32 and the accumulated deterioration amount storing block 33 are individually provided, the short-time deterioration amount storing block 32 and the accumulated deterioration amount storing block 33 can also be configured as one storing portion.

### [Memory Capacity and Bus Width Required for Realizing System]

A description will now be given with respect to a memory capacity and a bus width required for realizing the burn-in correcting portion 11. Hereinafter, it is supposed that a half period of luminance deterioration when the organic EL panel module 12 is continuously made to emit a light at the luminance of 100% is 30,000 hours. In this case, a data width required for storing the total deterioration amount for the half period can be obtained as follows. Firstly, the number of frames corresponding to the half period is obtained. Note that, it is supposed that the number of frames per one second is 60 frames.

The number of frames up to half period=30,000 hours×60 minutes×60 seconds×60 frames

The half period means a period of time required for the luminance level to be reduced from 100% to 50%. Therefore, a deterioration amount (%) of the luminance level per one frame is given by:

$$\begin{matrix}deterioration amount ( \% ) per one frame = 50 \% \div ( \begin{matrix}30 , 000 \times 60 \times \\ 60 \times 60\end{matrix} ) \\ = 7.716 \times {10}^{- 9}\end{matrix}$$

However, this value is one when the luminance of 100% is continuously outputted, and an actual video signal gets an arbitrary gradation value. For example, when a resolution of the gradation is 256 (8 bits), for realizing the deterioration amount (%) per one frame, there is required at least the bit width given by the following relationship:

$$\begin{matrix}deterioration amount ( \% ) per one frame = 7.716 \times {10}^{- 9} \div 256 \\ = 3 \times {10}^{- 11} ( 40 bit width ) \end{matrix}$$

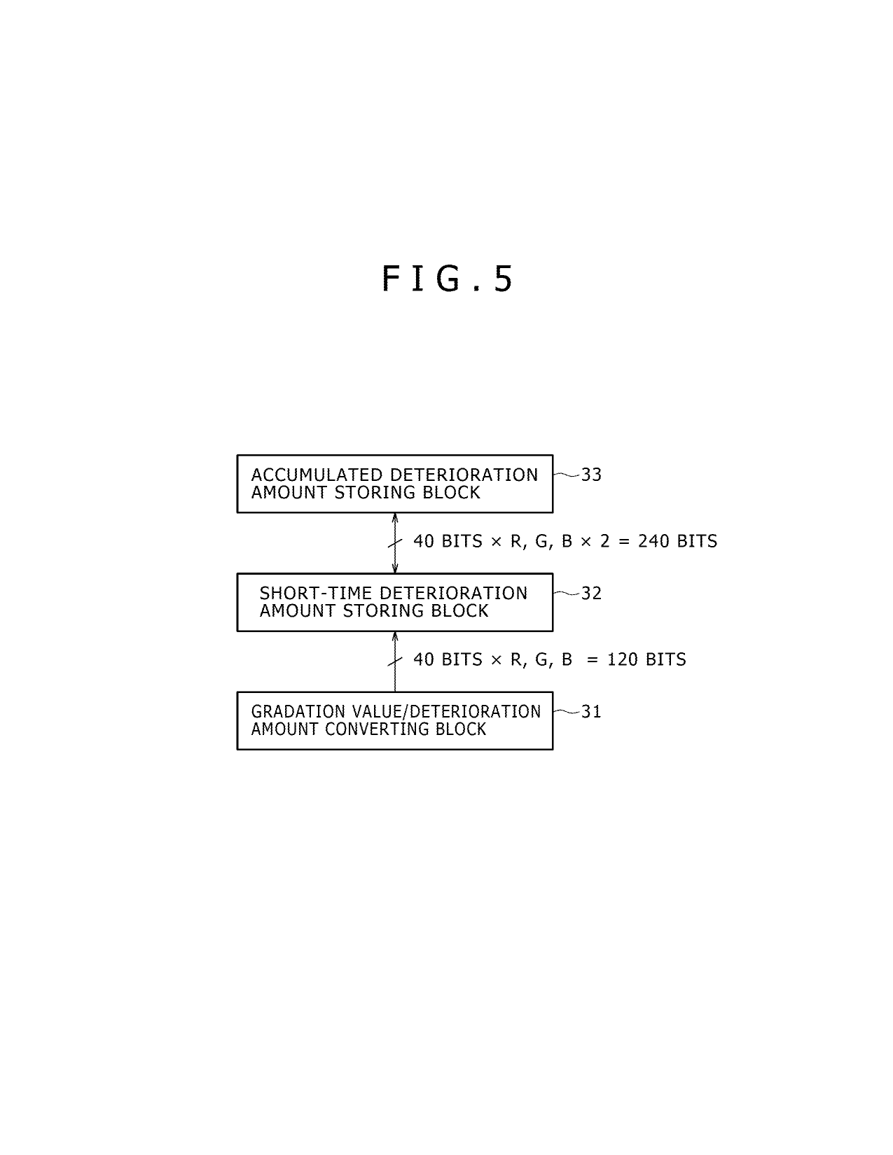

That is to say, data processing for 40 bit width is required for an arithmetic operation and storage of the deterioration amount generated in real time (every frame). FIG. 5 shows a relationship between the processing devices and the bus widths for realizing this processing operation. For example, a data line for 40 bits for each basic light emission color, that is, 120 bits in total is required between the gradation value/deterioration amount converting block 31 and the short-time deterioration amount storing block 32.

In addition, for example, a data line for 40 bits for load and read for each basic light emission color, that is, 240 bits in total is required between the short-time deterioration amount storing block 32 and the accumulated deterioration amount storing block 33. The reason why the double data width is required is because the data is firstly loaded into a place where the deterioration amount difference preserved is subjected to the calculation processing, and the reading and writing processing for preserving the calculated value is executed at the same time. In such a manner, the data width becomes larger as the period of time for preserving the data on the deterioration amount is longer, or the resolution of the gradation is smaller.

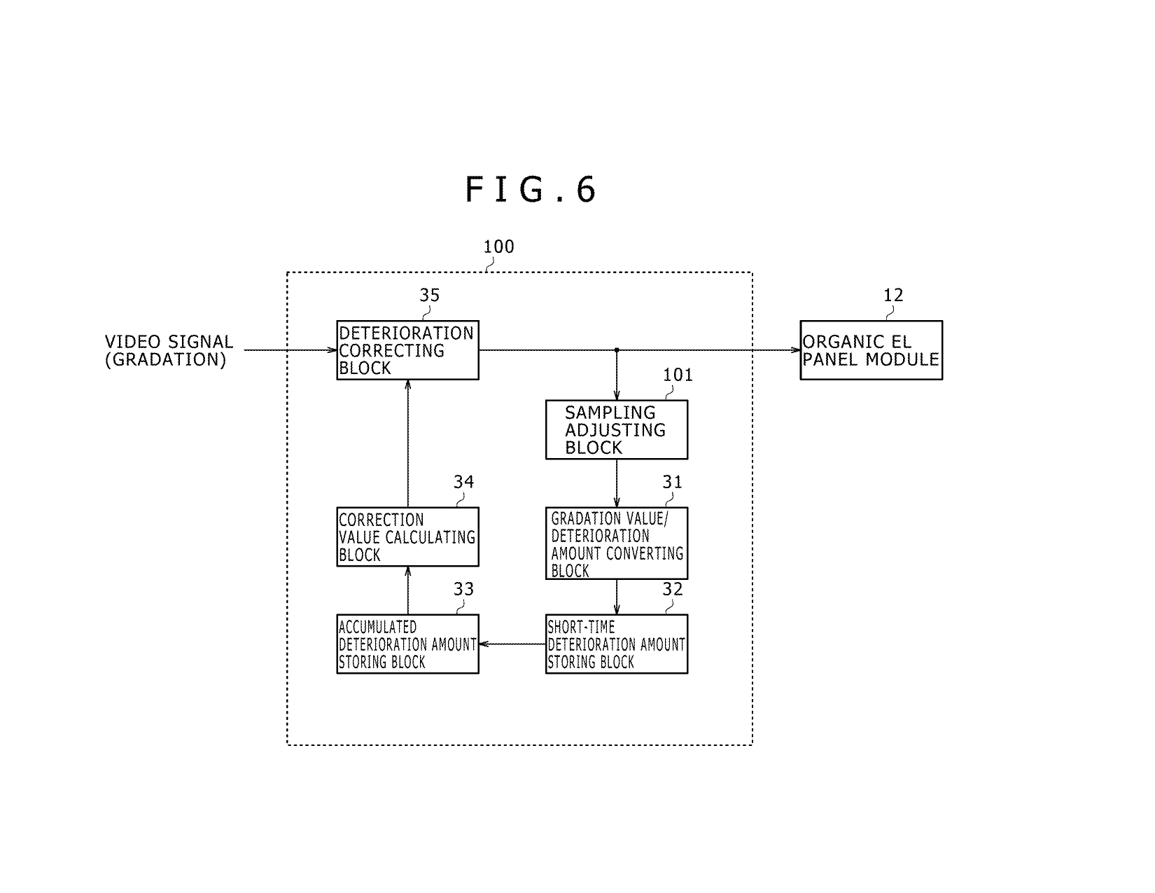

A description will now be given with respect to the burn-in correcting portion which enables both of the memory capacity and the bus width to be reduced. FIG. 6 is a block diagram showing a configuration of another burn-in correcting portion. A burn-in correcting portion 100 shown in FIG. 6 is identical in configuration to the burn-in correcting portion 11 shown in FIG. 2 except that a sampling adjusting block 101 is added. The blocks in the burn-in correcting portion 100 shown in FIG. 6 which are the same as those in the burn-in correcting portion 11 shown in FIG. 2 are designated by the same reference numerals, respectively, and a description thereof is suitably omitted here for the sake of simplicity. The burn-in correcting portion 100 shown in FIG. 6 composes part of the display device similarly to the case of the burn-in correcting portion 11 shown in FIG. 2.

The sampling adjusting block 101 of the burn-in correcting portion 100 shown in FIG. 6 has a function in which all of the frames of the video signal (frames) supplied thereto from the deterioration correcting block 35 are not made a processing object, but the sampling is carried out in a thinning-out style. This sampling is carried out at equal intervals, carried out at random, carried out every sub-area obtained through division, or carried out based on a combination thereof. The adjustment of the sampling which such a sampling adjusting block 101 carries out will be described below.

### Case where Sampling is Carried Out at Equal Intervals

### First Example

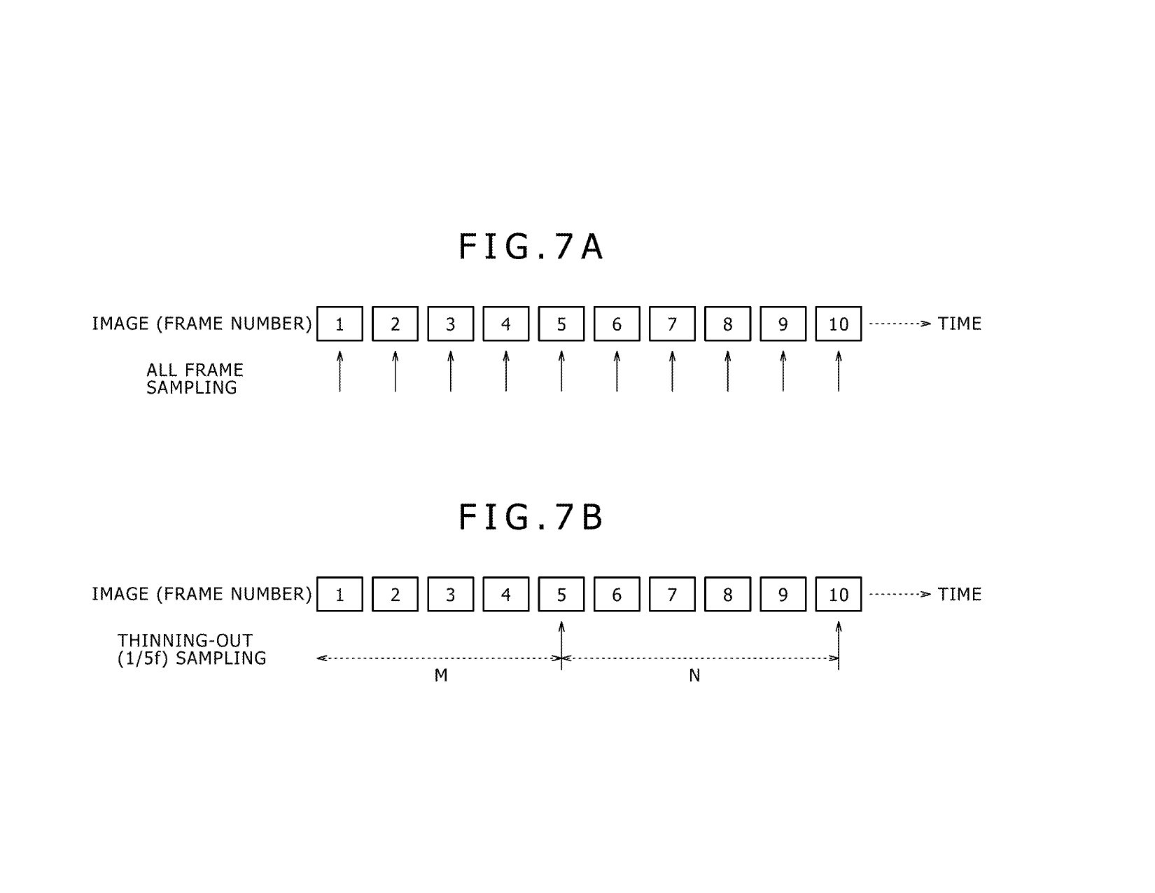

Firstly, a description will be given by exemplifying a case where the sampling is carried out at equal intervals with reference to FIGS. 7A and 7B. For the purpose of a reference, FIG. 7A shows a case where no sampling is carried out. FIG. 7B shows the case where the sampling is carried out at the equal intervals. In FIGS. 7A and 7B, a quadrilateral having a numerical number described therein represents one frame, and the numerical number described in the quadrilateral represents a frame number. In these figures, it is shown that time is gained toward the right-hand side (as the numerical number increases). In addition, in the figures, an arrow mark directed upward represents a position (frame) where the sampling is carried out.

Referring now to FIG. 7A, the frames having the frame numbers 1 to 10 are supplied from the deterioration correcting block 35 to the gradation value/deterioration amount converting block 31 shown in FIG. 2. The gradation value/deterioration amount converting block 31 processes the frames having the frame numbers 1 to 10 in the supply order. Therefore, as shown in FIG. 7A, the frames having the frame numbers 1 to 10 are all sampled to be processed.

The frames supplied from the deterioration correcting block 35 are supplied to the gradation value/deterioration amount converting block 31 shown in FIG. 6 through the sampling adjusting block 101. The sampling adjusting block 101, for example, samples predetermined frames from the frames which are supplied in the manner as shown in FIG. 7B.

In the case shown in FIG. 7B, the frames having the frame numbers 1 to 10 are supplied from the deterioration correcting block 35 to the sampling adjusting block 101. The sampling adjusting block 101 samples the frame having the frame number 5 and the frame having the frame number 10 of the frames having the frame numbers 1 to 10 supplied thereto, and outputs the frame having the frame number 5 and the frame having the frame number 10 to the gradation value/deterioration amount converting block 31 in the subsequent stage. Therefore, the gradation value/deterioration amount converting block 31 processes the frame having the frame number 5 and the frame having the frame number 10.

In the case shown in FIG. 7B, there is shown the case where the sampling is carried out every five frames. That is to say, there is shown the case where one sampling is carried out every five frames. When let a period M of time be a period of time for which the frames having the frame numbers 1 to 5 are supplied, and let a period N of time be a period of time for which the frames having the frame numbers 6 to 10 are supplied, one frame is sampled from the period M of time, and one frame is sampled from the period N of time. In this case, the period M of time and the period N of time are periods of time having the same time length. Therefore, the sampling is carried out at the equal intervals.

The frame which has been sampled from the predetermined period of time in such a manner is treated as a representative frame which represents other frames within the period of time concerned. The representative frame is provided in order that all of other frames within the period of time concerned may be regarded as making the same light emission as that of the representative frame to be processed. That is to say, in this case, the representative frame in the period M of time is the frame having the frame number 5, and thus each of the frames having the frame numbers 1 to 5 is treated as making the same light emission as that of the frame having the frame number 5. Likewise, the representative frame in the period N of time is the frame having the frame number 10, and thus each of the frames having the frame numbers 6 to 10 is treated as making the same light emission as that of the frame having the frame number 10.

In this case, when one frame is sampled every five frames to be processed in such a manner, the data on an accumulated deterioration amount stored becomes one-fifth. That is to say, the data amount stored on the short-time deterioration amount storing block 32 becomes one-fifth, and the data amount stored on the accumulated deterioration amount storing block 33 also becomes one-fifth.

The value of the accumulated deterioration amount stored in the accumulated deterioration amount storing block 33 becomes small in such a manner. Therefore, the correction value calculating block 34 executes a processing for converting the accumulated deterioration amount into a deterioration amount which is “thinning-out number-fold” as compared with the case where all of the frames are sampled. In this case, the “thinning-out number-fold” means quintuple. That is to say, in this case, one sheet of representative frame is treated as the frames for the five sheets. Therefore, the value of the representative frame is made quintuple, whereby the accumulated deterioration amount equal to that in the case where the frames for the five sheets are processed is accumulated, thereby calculating the correction value.

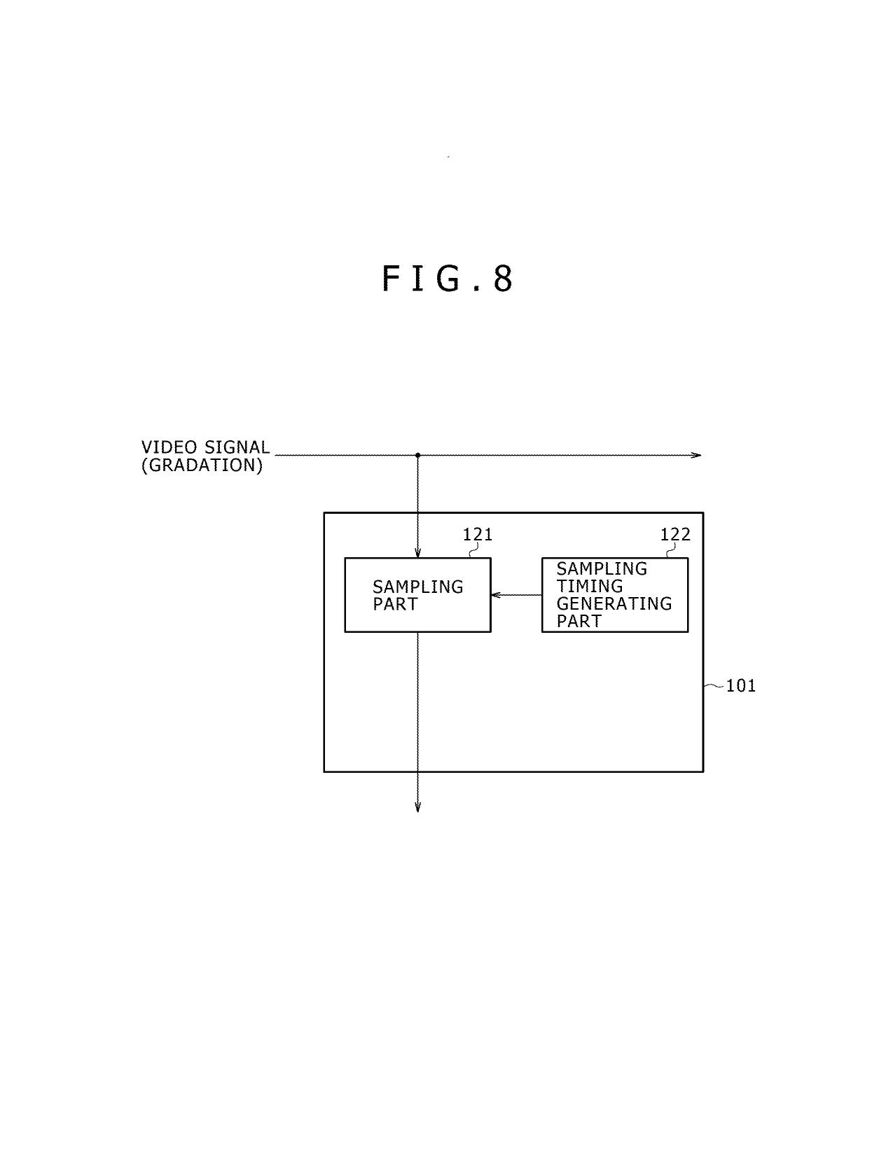

The sampling adjusting block 101 configured to execute the processing for thinning out the frames can be configured as shown in FIG. 8. The sampling adjusting block 101 includes a sampling part 121 and a sampling timing generating part 122. The sampling part 121 samples the frames supplied thereto at timings instructed by the sampling timing generating part 122.

For example, when as with the case described above, the sampling is carried out every five frames, the sampling timing generating part 122 issues an instruction to the sampling part 121 when the fifth frame is supplied to the sampling part 121. The sampling part 121 outputs the frame supplied thereto from the deterioration correcting block 35 to the gradation value/deterioration amount converting block 31 in the subsequent stage in accordance with the instruction issued thereto. The sampling is carried out in the sampling adjusting block 101 in such a manner.

As described above, the frames are thinned out to be processed in such a manner, whereby it is possible to reduce the amount of data to be stored. However, since one sheet of representative frame is treated as the frames for the predetermined number of sheets (for example, five sheets), it is possible that an error is generated as compared with the case where all of the frames are processed. Even if the error is generated, from following reasons, an influence by the error is small.

For example, in such a case where a still image is displayed on the organic EL panel module 12, all of the five sheets of frames become the same image. Therefore, it is obvious that even when one sheet of representative frame is treated as the frames for the five sheets, no error is generated. In such a case where a moving image is displayed on the organic EL panel module 12, there is the possibility that the image is changed every one frame. Therefore, an error is generated between such a case where the five frames are individually processed and such a case where one frame of the five frames is processed as the representative frame. However, since the image is changed every frame in the case of the moving image, the images are averaged, and thus there is caused a situation in which the burn-in is originally hard to be generated.

In addition, the number of moving images such that the luminance is furiously changed is small. In other words, it is rare that a scene such that the luminance is furiously changed continues for a relatively long time, and thus many scenes are such that the luminance is gradually changed. For example, when frames like five frames are observed for a short time, it is rare that the luminance is furiously changed over all of the five frames. The moving image is such that the luminance is gradually changed. Therefore, for example, when the frames adjacent to each other in terms of time are compared with each other, the similar images are obtained from such frames. Thus, it is considered that a change is not generated so much in the luminance or the like (there is no large change).

From such a situation, when the interval of the sampling is short, an error is not visually recognized. Thus, the influence of the error is small and the error can be made to fall within an allowable range. In addition, as will be described below, the sampling may also be carried out at random intervals, thereby reducing the error.

### Case where Sampling is Carried Out at Random Intervals

### Second Example

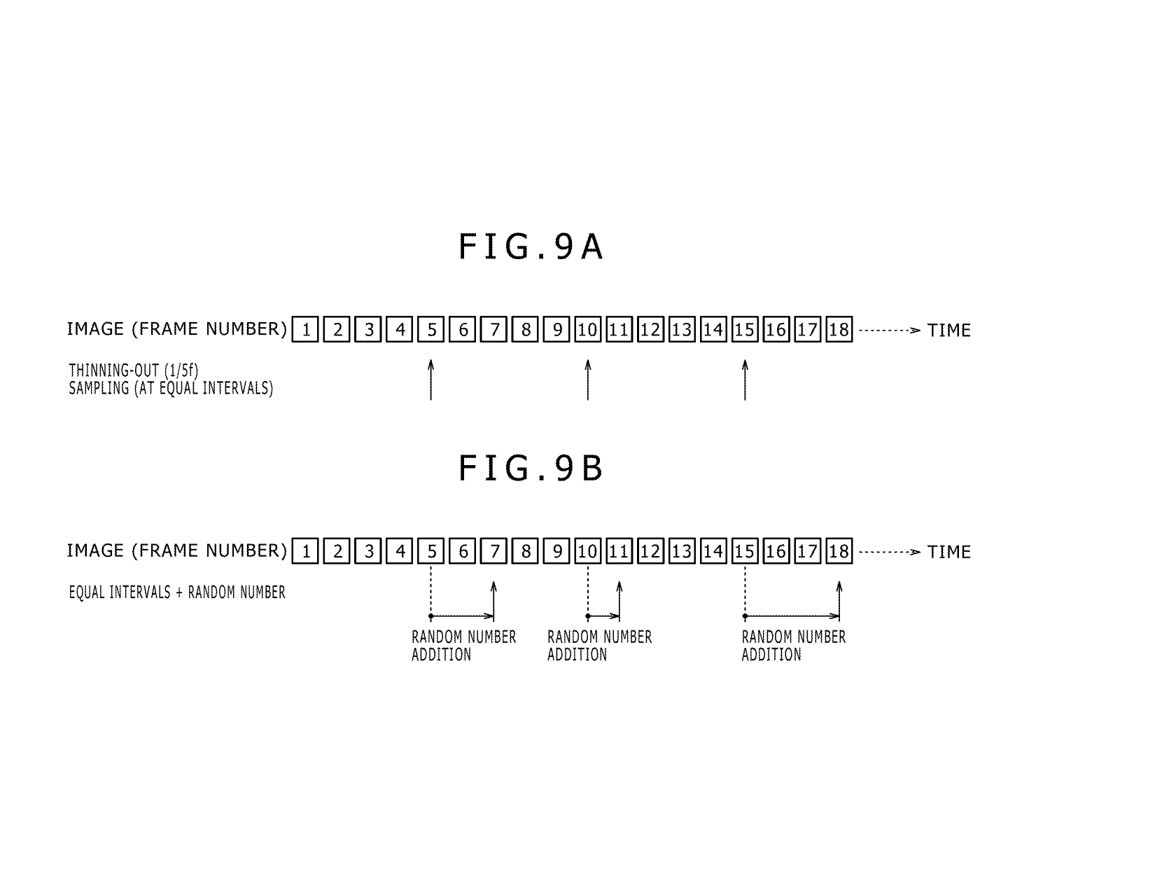

A description will now be given by exemplifying the case where the sampling is carried out at random intervals with reference to FIGS. 9A and 9B. For the purpose of a reference, FIG. 9A shows the above case where the sampling is carried out at the equal intervals. FIG. 9B shows the case where the sampling is carried out at the random intervals. In FIGS. 9A and 9B as well, similarly to the case of FIGS. 7A and 7B, a quadrilateral having a numerical number described therein represents one frame, and the numerical number described in the quadrilateral represents a frame number. In these figures, it is shown that time is gained toward the right-hand side (as the numerical number increases). In addition, in the figures, an arrow mark directed upward represents a position (frame) where the sampling is carried out.

FIG. 9A shows the above case where the sampling is carried out at the equal intervals. In the case shown in FIG. 9A, the frame numbers 1 to 18 are illustrated, and it is shown that, of the frames having the frame numbers 1 to 18, the frames having the frame numbers 5, 10, and 15 are sampled. In this case as well, there is shown the case where the sampling is carried out every five frame.

FIG. 9B shows the case where the sampling is carried out at the random intervals. Even in the case where the sampling is carried out at the random intervals, basically, the case where the sampling is carried out at the equal intervals is treated as a reference. Referring now to FIG. 9B, it is shown that the frames having the frame numbers 7, 11, and 18 are sampled.

A random number 2 generated is added to the frame number 5 and as a result, the frame having the frame number 7 is sampled. Likewise, a random number 1 generated is added to the frame number 10 and as a result, the frame having the frame number 11 is sampled. A random number 3 generated is added to the frame number 15 and as a result, the frame having the frame number 18 is sampled.

In such a manner, in addition to the timings corresponding to the equal intervals, the position of the frame to be sampled is shifted by the random number, whereby the sampling can be carried out at the random intervals.

It is noted that since in this case, the timing at which the sampling is carried out every five frames is treated as the reference, the numerical number which is generated as the random number is any one of 0, 1, 2, 3, and 4. For example, when the random number which is generated when the frame having the frame number 5 is intended to be sampled is “0,” the frame having the frame number 5 is sampled. Likewise, when the random number is “1,” the frame having the frame number 6 is sampled. When the random number is “2,” the frame having the frame number 7 is sampled. When the random number is “3,” the frame having the frame number 8 is sampled. When the random number is “4,” the frame having the frame number 9 is sampled.

If the random number is “5,” then, the frame having the frame number 10 will be sampled. The frame having the frame number 10 is a frame which may be sampled even at the timings corresponding to the equal intervals each treated as the reference, and is also a frame which is sampled when the random number is “0.” Therefore, although one sheet of frame should be sampled every period of time, there is caused a trouble such that a period of time for which no frame is sampled exists. From such a reason, control needs to be carried out in such a way that the numerical number 5 or more is prevented from being generated as the random number.

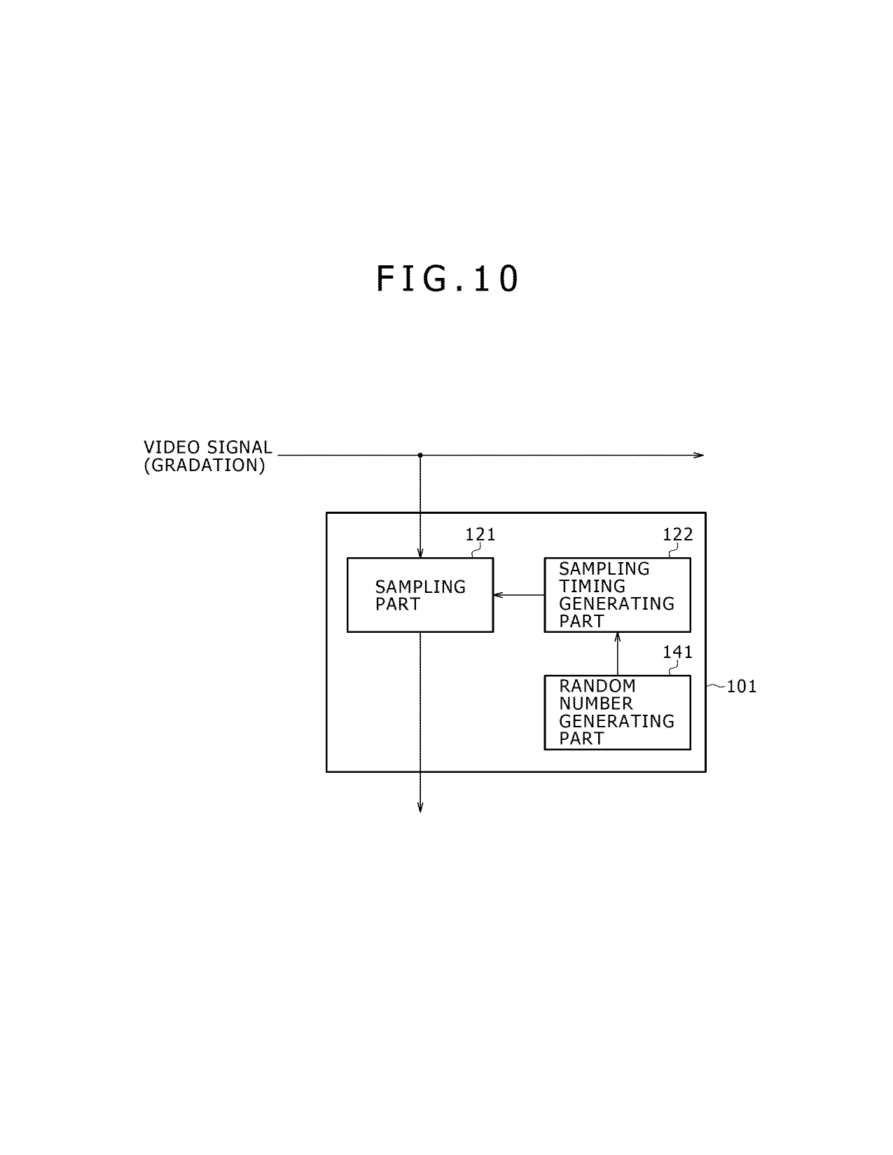

When the sampling is carried out at the random intervals by using the random numbers in such a manner, the sampling adjusting block 101 has a configuration as shown in FIG. 10. The sampling adjusting block 101 as shown in FIG. 10 includes the sampling part 121, the sampling timing generating part 122, and a random number generating part 141. The sampling adjusting block 101 shown in FIG. 10 has a configuration in which the random number generating part 141 is added to the sampling adjusting block 101 shown in FIG. 8.

Similarly to the case of the sampling adjusting block 101 shown in FIG. 8, the sampling part 121 samples predetermined frames of the frames supplied thereto in accordance with the instruction issued from the sampling timing generating part 122, and outputs the data on the predetermined frames to the gradation value/deterioration amount converting block 31 in the subsequent stage. The sampling timing generating part 122 holds therein the numerical value when the sampling is carried out at the equal intervals, for example, 5 and adds the values of the random numbers generated and supplied thereto from the random number generating part 141 to the numerical value concerned, thereby generating the timings at which the sampling is intended to be carried out.

In the case as well where the sampling is carried out at random in such a manner, similarly to the above case where the sampling is carried out at the equal intervals, it is possible to reduce both of the amount of data stored in the short-time deterioration amount storing block 32, and the amount of data stored in the accumulated deterioration amount storing block 33.

The value of the accumulated deterioration amount stored in the accumulated deterioration amount storing block 33 becomes small in such a manner. Therefore, the correction value calculating block 34 executes the processing adapted to convert the accumulated deterioration amount into the deterioration amount which is “thinning-out number-fold” as compared with the case where all of the frames are sampled. In this case, the “thinning-out number-fold” becomes (5+the value of the random number)-fold. That is to say, in this case, one sheet of representative frame is treated as the frames for five to nine sheets. Therefore, the value of the representative frame is made five to nine-fold, whereby the accumulated deterioration amount equal to that in the case where the frames for five to nine sheets are processed is accumulated, thereby calculating the correction value.

When the sampling is carried out at random in such a manner, a following effect can be further expected as compared with the case where the sampling is carried out at the equal intervals. That is to say, firstly, the sampling is carried out at random, thereby making it possible to absorb an error. As described above, although in the case of a still image, no error is generated even when the sampling is carried out at the equal intervals, in the case of a moving image, there is the possibility that an error is generated.

For example, let us consider a case where a moving image such that the luminance is furiously changed is processed. When such a moving image is sampled at equal intervals, for example, in such a case where the interval of the sampling and the interval at which a frame having low luminance comes agree with each other, the frame having low luminance is processed as the representative frame. In such a case, although the representative frame has low luminance, since there is the possibility that any of the frames other than the representative frame has high luminance, it is feared that an error is generated and is then accumulated.

However, even in the case of the moving image such that the luminance is changed at equal intervals, by sampling at random intervals, it is possible to disperse the case where the representative frame becomes the frame having high luminance, and the case where the representative frame becomes the frame having low luminance. As a result, the possibility that an error is generated is reduced, thereby making it possible to prevent the error from being stored. In other words, in the case of the cyclic moving image, there is the possibility that when the thinning-out sampling is carried out at equal intervals, the images are not averaged and thus the error is stored. However, the sampling is carried out at random intervals, whereby the images are averaged, thereby making it possible to prevent the error from being stored.

### Case where Area is Divided and Sampling is Carried Out at Equal Intervals

### Third Example

In the first and second examples of the embodiment described above, the description has been given by exemplifying the cases where the sampling is carried out at equal intervals and at random intervals. In other words, the description has been given by exemplifying the case where the sampling is carried out with the division being carried out made in terms of time. Next, a description will now be given with respect to a case where the division is carried out in terms of time and an area of one frame is divided into plural sub-areas, and under this condition, the sampling is carried out every sub-area. In this case as well, as far as the time division method concerned, there are a method of carrying out the sampling at equal intervals, and a method of carrying out the sampling at random intervals. Firstly, a description will now be given by exemplifying the method of carrying out the sampling at equal intervals.

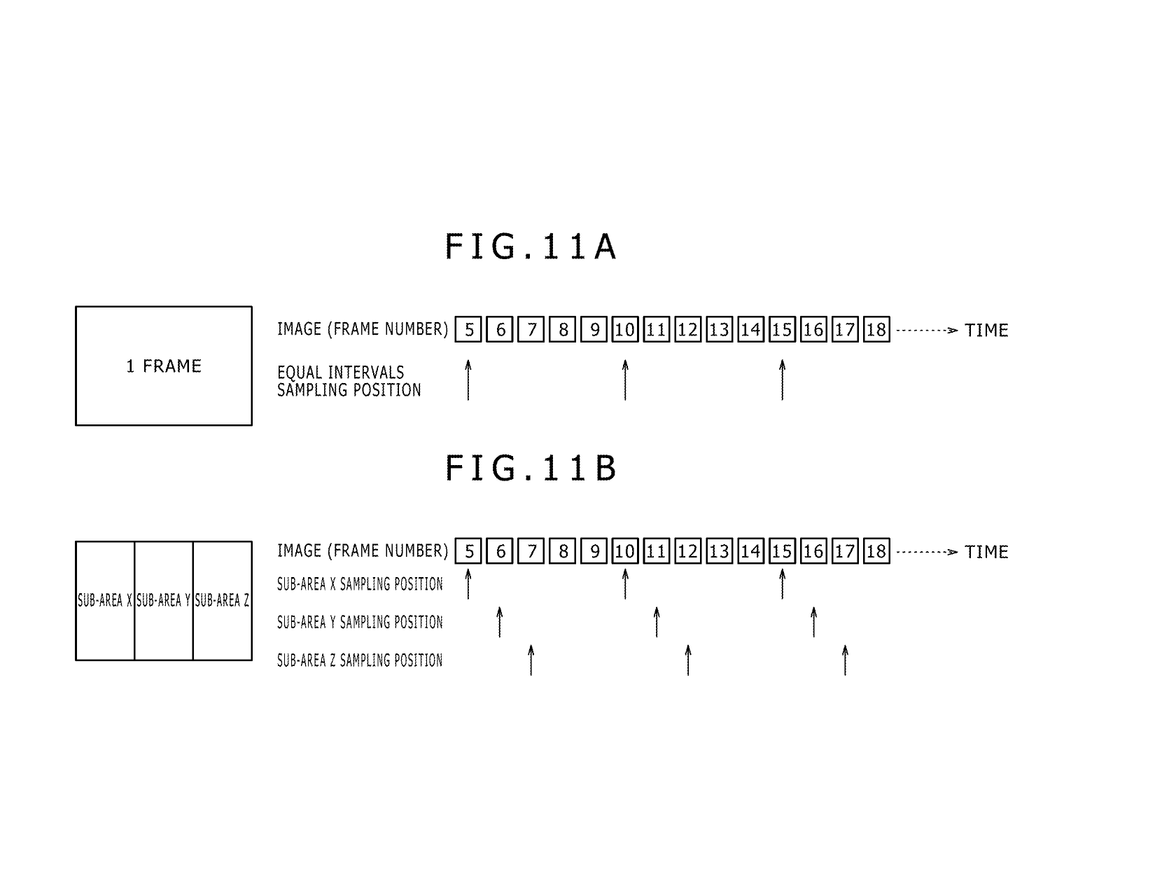

A description will now be given with respect to the case where the area of one frame is divided into plural sub-areas, and under this condition, the sampling is carried out with reference to FIGS. 11A and 11B. For the purpose of a reference, FIG. 11A shows the case where the area of one frame described above is not divided, and the sampling is carried out at equal intervals. Also, FIG. 11B shows the case where the area of one frame is divided, and the sampling is carried out at equal intervals. In FIGS. 11A and 11B as well, similarly to each of the cases of FIGS. 7A and 7B, and FIGS. 9A and 9B, a quadrilateral having a numerical number described therein represents one frame, and the numerical number described in the quadrilateral represents a frame number. In these figures, it is shown that time is gained toward the right-hand side (as the numerical number increases). In addition, in the figures, an arrow mark directed upward represents a position (frame) where the sampling is carried out.

FIG. 11A shows the above case where the sampling is carried out at equal intervals. In this case, as shown on the left-hand side in FIG. 11A, data for one frame is acquired in one sampling operation. That is to say, for example, when the sampling is carried out at equal intervals every five frames, data for one frame in the frame having the frame number 5 is sampled. Also, data for one frame in the frame having the frame number 10 is sampled, and data for one frame in the frame having the frame number 15 is sampled.

On the other hand, when as shown in FIG. 11B, the area is divided into sub-areas and the sampling is carried out at equal intervals, data in each of the sub-areas is sampled at equal intervals. As shown on the left-hand side in FIG. 11B, the area of one frame is divided into three sub-areas: a sub-area X; a sub-area Y; and a sub-area Z. In one sampling operation, data within any one of the three sub-areas X, Y, and Z is acquired. For example, the sampling is carried out in the manner as shown on the right-hand side in FIG. 11B.

Data within the sub-area X of the frame having the frame number 5 is sampled, data within the sub-area Y of the frame having the frame number 6 is sampled, and data within the sub-area Z of the frame having the frame number 7 is sampled. In this case, the data for one frame is acquired in the three sampling operations.

Likewise, data within the sub-area X of the frame having the frame number 10 is sampled, data within the sub-area Y of the frame having the frame number 11 is sampled, and data within the sub-area Z of the frame having the frame number 12 is sampled. As a result, the data for one frame is acquired in the three sampling operations.

When attention is paid to the sub-area X, since the frames having the frame numbers 5, 10, and 15 are sampled, the sampling is carried out at the equal intervals every five frames. Likewise, when attention is paid to the sub-area Y, since the frames having the frame numbers 6, 11, and 16 are sampled, the sampling is carried out at the equal intervals every five frames. Also, likewise, when attention is paid to the sub-area Z, since the frames having the frame numbers 7, 12, and 17 are sampled, the sampling is carried out at the equal intervals every five frames.

When in such a manner, the area of one frame is divided into plural sub-areas, and the sampling is carried out in the time division manner, the sampling adjusting block 101 can adopt a configuration comparable to that as shown in FIG. 8. The configuration shown in FIG. 8 (the first example of the embodiment) is the configuration of the sampling adjusting block 101 when the sampling is carried out at equal intervals. However, the configuration of the sampling adjusting block 101 in the third example of the embodiment is different from the configuration of the sampling adjusting block 101 in the first example of the embodiment in that when the sampling part 121 carries out the sampling in accordance with the instruction issued from the sampling timing generating part 122, the sampling part 121 extracts data within the predetermined sub-area(s) and outputs the data thus extracted to the gradation value/deterioration amount converting block 31 in the subsequent stage.

In addition, in this case, the amount of data which is outputted from the sampling adjusting block 101 to the gradation value/deterioration amount converting block 31 in the subsequent stage becomes one-third of that of one frame. Likewise, the amount of data which is outputted from the gradation value/deterioration amount converting block 31 to the short-time deterioration amount storing block 32, and the amount of data which is outputted from the short-time deterioration amount storing block 32 to the accumulated deterioration amount storing block 33 each become one-third of that of one frame. Therefore, a band width of each of these memories can be reduced to one-third. That is to say, the area of one frame is divided into plural sub-areas and the sampling is carried out for the plural sub-areas in the time division manner, whereby it is possible to largely reduce the band width of each of these memories.

Similarly to the case of each of the first and second examples of the embodiment described above, all of the frames are not processed, but are thinned out to be processed. Therefore, it is also possible to reduce the capacity of each of the memories included in the short-time deterioration amount storing block 32 and the accumulated deterioration amount storing block 33.

### Case where Area is Divided and Sampling is Carried Out at Random Intervals

### Fourth Example

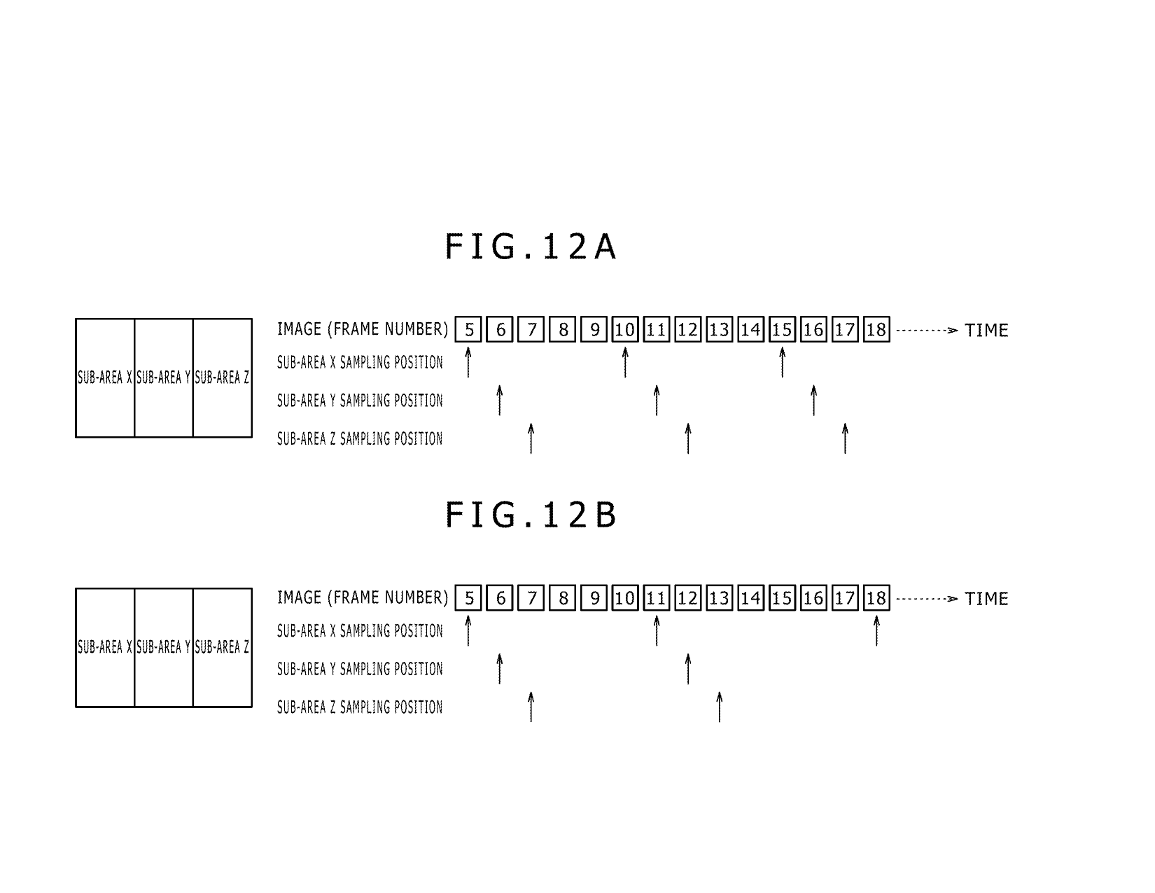

Next, a description will now be given with respect to a case where the area of one frame is divided into plural sub-areas, and under this condition, the sampling is carried out at random intervals. FIGS. 12A and 12B are respectively diagrams explaining the case where the area of one frame is divided into plural sub-areas, and under this condition, the sampling is carried out at random intervals. For the purpose of a reference, FIG. 12A shows the case described above where the area is divided, and under this condition, the sampling is carried out at the equal intervals. FIG. 12B shows the case where the area is divided into plural sub-areas, and under this condition, the sampling is carried out at random intervals. In FIGS. 12A and 12B as well, similarly to the case of each of FIGS. 7A and 7B, FIGS. 9A and 9B, and FIGS. 11A and 11B, a quadrilateral having a numerical number described therein represents one frame, and the numerical number described in the quadrilateral represents a frame number. In these figures, it is shown that time is gained toward a right-hand side (as the numerical number increases). In addition, in the figures, an arrow mark directed upward represents a position (frame) where the sampling is carried out.

As described above with reference to FIG. 11B, in the case shown in FIG. 12A, the area of one frame is divided into three sub-areas, and under this condition, the sampling is carried out at the equal intervals. Therefore, for example, when attention is paid to the sub-area X, the sampling is carried out every five frames. That is to say, in this case, the frames having the frame numbers 5, 10, and 15 are sampled.

FIG. 12B shows the case where the area is divided into plural sub-areas, and under this condition, the sampling is carried out at random intervals. Similarly to the case described above with reference to FIG. 9B, in this case as well, even in the case where the sampling is carried out at random intervals, the case where the sampling is carried out at the equal intervals is basically treated as a reference. Referring now to FIG. 12B, when attention is paid to the sub-area X, the frames having the frame numbers 5, 11, and 18 are sampled.

A random number 0 generated is added to the frame number 5, and as a result, the frame having the frame number 5 is sampled. Likewise, a random number 1 generated is added to the frame number 10, and as a result, the frame having the frame number 11 is sampled. A random number 3 generated is added to the frame number 15, and as a result, the frame having the frame number 18 is sampled.

The sub-area Y is an area which is sampled from the frame next to the frame in which the sub-area X is sampled. When attention is paid to such a sub-area Y, the frames having the frame numbers 6, 12, and 19 (not shown) are sampled. Likewise, the sub-area Z is an area which is sampled from the frame next to the frame in which the sub-area Y is sampled. When attention is paid to such a sub-area Z, the frames having the frame numbers 7, 13, and 20 (not shown) are sampled.

The predetermined sub-area is treated as the reference, and the timing of the sampling for the predetermined sub-area treated as the reference is made random, whereby the area of one frame can be divided into plural sub-areas which can be in turn sampled at random intervals.

It is noted that since in this case, the timing at which the sampling is carried out every five frames is treated as the reference, and the area of one frame is divided into three sub-areas, the numerical number which is generated as the random number is any one of 0, 1, and 2. For example, when the random number which is generated when the frame having the frame number 5 is intended to be sampled is “2,” the frame having the frame number 7 is sampled. In this case, the sub-area X is sampled from the frame having the frame number 7, the sub-area Y is sampled from the frame having the frame number 8, and the sub-area Z is sampled from the frame having the frame number 9.

Even when in such a state, the random number generated in the frame having the frame number 10 is “0,” the sub-area X is sampled from the frame having the frame number 10. Therefore, it is prevented that plural sub-areas are sampled from the same frame.

However, if the setting is carried out in such a way that the numerical number “3” or more is also generated as the random number, it is possible that both of the sub-area Z and the sub-area X are sampled from the frame having the frame number 10. Therefore, a restriction needs to be imposed in such a way that as described above, any one of 0, 1, and 2 is generated as the random number. This restriction is determined depending on every how many frames the sampling is carried out at equal intervals or into how many sub-areas the area of one frame is divided.

When the sampling is carried out at random intervals by using the random numbers in such a manner, the configuration of the sampling adjusting block 101 is substantially the same as that in the second example of the embodiment shown in FIG. 10. Similarly to the sampling adjusting block 101 shown in FIG. 10, the sampling part 121 samples predetermined frames from the frames supplied thereto in accordance with the instruction issued from the sampling timing generating part 122. The sampling timing generating part 122 generates the timings with the values obtained by adding the random numbers generated in the random number generating part 141 to the reference values.

In addition, in the case where the area of one frame is divided into plural sub-areas and under this condition, the sampling is carried out, when the sampling part 121 carries out the sampling in accordance with the instruction issued from the sampling timing generating part 122, the sampling part 121 extracts data within the predetermined sub-area(s) and outputs the data thus extracted to the gradation value/deterioration amount converting block 31 in the subsequent stage.

Even when such a configuration is adopted, in this case, the amount of data which is outputted from the sampling adjusting block 101 to the gradation value/deterioration amount converting block 31 in the subsequent stage becomes one-third of that of one frame. Likewise, the amount of data which is outputted from the gradation value/deterioration amount converting block 31 to the short-time deterioration amount storing block 32, and the amount of data which is outputted from the short-time deterioration amount storing block 32 to the accumulated deterioration amount storing block 33 each become one-third of that of one frame. Therefore, the band width of each of these memories can be reduced to one-third. That is to say, the area of one frame is divided into plural sub-areas, and the sampling is carried out for the plural sub-areas in the time division manner, whereby it is possible to largely reduce the band width of each of these memories.

In addition, similarly to the case of each of the first to third examples of the embodiment described above, all of the frames are not processed, but are thinned out to be processed. Therefore, it is also possible to reduce the capacity of each of the memories included in the short-time deterioration amount storing block 32 and the accumulated deterioration amount storing block 33.

In each of the third example of the embodiment described above in which the area of one frame is divided, and under this condition, the sampling is carried out at the equal intervals, and the fourth example of the embodiment described above in which the area of one frame is divided, and under this condition, the sampling is carried out at the random intervals, the description has been given by exemplifying the case where the area of one frame is divided into three sub-areas, and the sampling is carried out in the time division manner. However, the present disclosure is by no means limited to the case where the area of one frame is divided into the three sub-areas. That is to say, the area of one frame may be divided into more than three sub-areas or may be divided into two sub-areas. However, when the area of one frame is divided too much, the interval of the sampling for one sub-area becomes long, and thus an error becomes easy to accumulate. Therefore, preferably, the number of divisions is set so that an error is hard to accumulate.

### Fifth Example

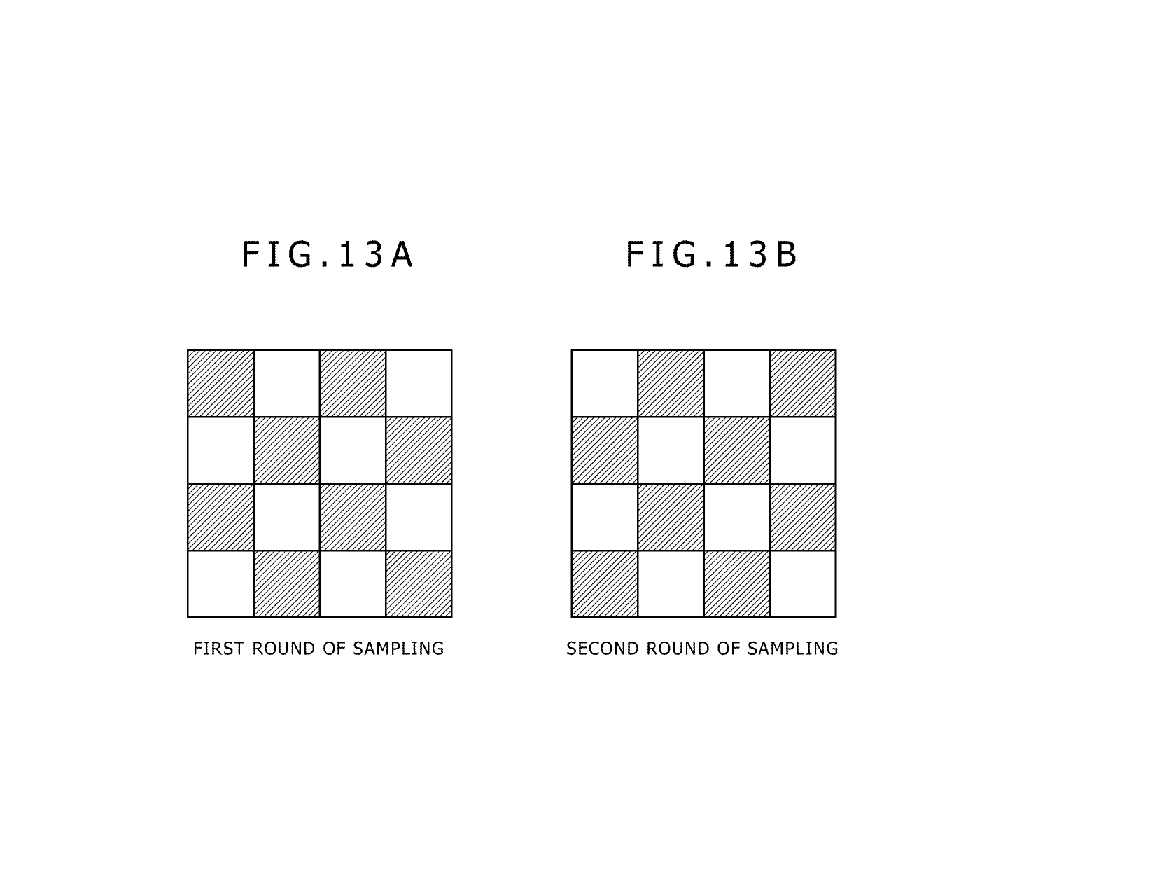

Although in each of the case shown on the left-hand side of FIG. 11B, and the case shown on the left-hand side of FIG. 12B, the area of one frame is longitudinally divided into three sub-areas, the area of one frame may be transversely divided into three sub-areas (plural sub-areas). The shape of sub-areas is by no means limited to the quadrilateral-like shape as shown in the third and fourth examples of the embodiment. For example, as a fifth example, the area of one frame may also be divided in a checkered pattern as shown in FIGS. 13A and 13B. The checkered pattern-like shape shown in FIG. 13A is a checkered pattern A, and the checkered pattern-like shape shown in FIG. 13B is a checkered pattern B. The checkered pattern, as shown in FIGS. 13A and 13B, is a lattice-like pattern.

Of the checkered pattern A and the checkered pattern B shown in FIGS. 13A and 13B, respectively, shaded portions are pixels (pixel groups) which are sampled in the phase of the sampling. A quadrilateral shaded portion may correspond to one pixel. In this case, data may be sampled from the pixels which are alternately disposed every one pixel. Or, a quadrilateral shaded portion may correspond to a pixel group including plural pixels. In this case, data may be sampled from the pixel groups which are alternately disposed every one pixel group.

When a quadrilateral shaded portion corresponds to a pixel group, as shown in FIGS. 13A and 13B, the shape of the quadrilateral may be either a square or a rectangle. When the rectangle is adopted as the shape of the quadrilateral, for example, it is also possible to adopt a rectangle having an aspect ratio corresponding to an aspect ratio of the organic EL panel module 12 (refer to FIG. 1).

When the sampling is carried out by using both of the checkered pattern A and the checkered pattern B in such a manner, it is thought that the area of one frame is divided into two sub-areas. That is to say, the checkered pattern A is applied from one frame acquired at a predetermined time, and data is extracted from the corresponding sub-area(s). Also, the checkered pattern B is applied from one frame acquired at a time next to the predetermined time, and data is extracted from the corresponding sub-area(s). In such a manner, data for one sheet of frame is acquired in two sampling operations.

The sampling is carried out by applying the checkered patterns in such a manner, whereby a following effect can be expected. When as described with reference to FIGS. 11A and 11B, and FIGS. 12A and 12B, the area of one frame is divided into plural sub-areas (the sub-areas X, Y, and Z) and the sampling is carried out every sub-area, there is the possibility that the frame to be treated differs every sub-area and thus the deterioration amount to be stored differs every sub-area. When the deterioration amount to be stored differs every sub-area, it is possible that this becomes an error which is in turn visually recognized by a user.

An error takes the form of a luminance difference. For example, with regard to such an error, it is possible that a boundary between each adjacent two sub-areas is visually recognized as a line by the user. The luminance difference is hard to visually recognize when an area in which the luminance difference is generated is small. Even if the error is generated, an area of one frame is divided in the checkered pattern as shown in FIGS. 13A and 13B, whereby it is possible to reduce the area in which the luminance difference is generated, and thus it becomes possible to cause the error to be hard to visually recognize.

When as described with reference to FIGS. 11A to 13B, the area of one frame is divided into plural sub-areas, and under this condition, the sampling is carried out, the size of each of the sub-areas may be fixed or may be made variable. For example, if as with the case shown on the left-hand side of FIG. 11B, the area of one frame is longitudinally divided into three sub-areas, and one frame has 30 lines in the longitudinal direction, one sub-area may be fixed so as to have ten lines or the number of lines in one sub-area may be made variable so as to differ every sampling.

In the case where the number of lines is variable, when the sampling is carried out from the three sub-areas in the three sampling operations, the numbers of lines of the individual sub-areas are set in such a way that data for 30 lines is acquired. For example, the numbers of lines of the individual sub-areas are set in such a way that the sub-area X has eight lines, the sub-area Y has 14 lines, and the sub-area Z has eight lines. The size of the sub-area is made variable in such a manner, whereby it is possible to disperse an error between adjacent two sub-areas appearing on the boundary between the sub-areas, and thus it is possible to reduce the possibility that the error is visually recognized by the user.

[Case where Equal Intervals are Made Variable (Modified Changes)]

In each of the first and fourth examples of the embodiment described above, the description has been given in such a way that the sampling is carried out at equal intervals. Also, even when the sampling is carried out at random intervals, the description has been given in such a way that the sampling is carried out by using each of the timings at which the sampling is carried out at equal intervals as the reference. Although in each of the first to fourth examples of the embodiment described above, the equal interval has been described as five frames, the interval of five frames may be made a fixed value or may be made a variable value.

For example, here, let us consider both of a case where a still image is displayed and a case where a moving image is displayed. In the case of the still image, frames having the same image are continuously displayed for a predetermined time. In recent years, the number of television receivers which not only can display a program being broadcasted but also can display a still image captured with a digital still camera or the like by a function referred to as a slide show or the like is also being increased.

When a still image is displayed on a television receiver by such a function referred to as a slide show, the display such that the same still image is displayed for a predetermined time (described as a time A), and after a lapse of the time A, the display is changed over to a next still image is repetitively carried out. In such a case, for the time A for which the same still image is displayed, even when one sheet of frame of the frames is processed as the representative frame, no error is generated at all. In consideration of such a situation, the time A for which the same still image is displayed may be set as the time of the equal interval, and the sampling may be carried out every time A.

In addition, the sampling may be carried out at the timing at which the still image is changed over to another one. For example, while the slide show is carried out, even when the time A does not elapse, the display is sometimes changed over to the next still image by the user. In such a case, the change-over of the display of the still image may be detected, and the sampling may be carried out at that timing.

When the sampling is carried out by utilizing such a change-over of the image, even in the moving image, for example, a scene change or the like may be detected, and the intervals (the number of frames) at which the sampling is carried out may be made variable in correspondence to the detection concerned.

By applying any of the first to fifth examples of the embodiment of the present disclosure described above, when the sampling is carried out in which the accumulated deterioration amount in the burn-in correcting portion 100 (refer to FIG. 6) configured to execute the processing adapted to correct the burn-in of the organic EL panel module 12 is stored, as described above, the frames which are intended to be sampled are thinned out, or the sampling is carried out every sub-area, whereby the capacity of the memory to be used can be reduced without reducing the precision. When the sampling is carried out every sub-area, the band of the memory can be further reduced.

### [Electronic Apparatus]

An electronic apparatus according to the embodiment of the present disclosure includes the organic EL display device as the display device according to the embodiment of the present disclosure. In this case, as described above, the organic EL display device includes the sampling adjusting block 101, the gradation value/deterioration amount converting block 31, the short-time deterioration amount storing block 32, the accumulated deterioration amount storing block 33, the correction value calculating block 34, and the deterioration correcting block 35. In this case, the sampling adjusting block 101 samples image data continuously inputted thereto at a predetermined intervals. The gradation value/deterioration amount converting block 31 converts a gradation value of an image based on the image data sampled in the sampling adjusting block 101 into a deterioration amount. The short-time deterioration amount storing block 32 and the accumulated deterioration amount storing block 33 calculate and store a difference in deterioration between a correction object pixel and a reference pixel by using the deterioration amount obtained through the conversion in the gradation value/deterioration amount converting block 31. The correction value calculating block 34 calculates a correction amount required for resolving the deterioration amount difference stored in the short-time deterioration amount storing block 32 and the accumulated deterioration amount storing block 33 based on an estimated deterioration amount within a correction period of time. Also, the deterioration correcting block 35 corrects the gradation value of the corresponding pixel with the correction amount thus calculated.

### Application Examples

The display device (the burn-in correcting portion 100) of the embodiment in the present disclosure which has been described so far has a flat panel shape, and can be applied to various kinds of electronic apparatuses, for example, a digital camera, a notebook-size personal computer, a mobile phone, a video camera, and the like. The display device described above can be applied to display devices, of electronic apparatuses in all fields, in each of which a drive signal inputted from the outside to the electronic apparatus, or a drive signal generated in the electronic apparatus is displayed in the form of an image or a video image. Hereinafter, examples of electronic apparatuses to each of which such a display device is applied will be described. Each of the electronic apparatuses basically includes a main body configured to process information, and a display device configured to display thereon an image based on information inputted to the main body or information outputted from the main body.

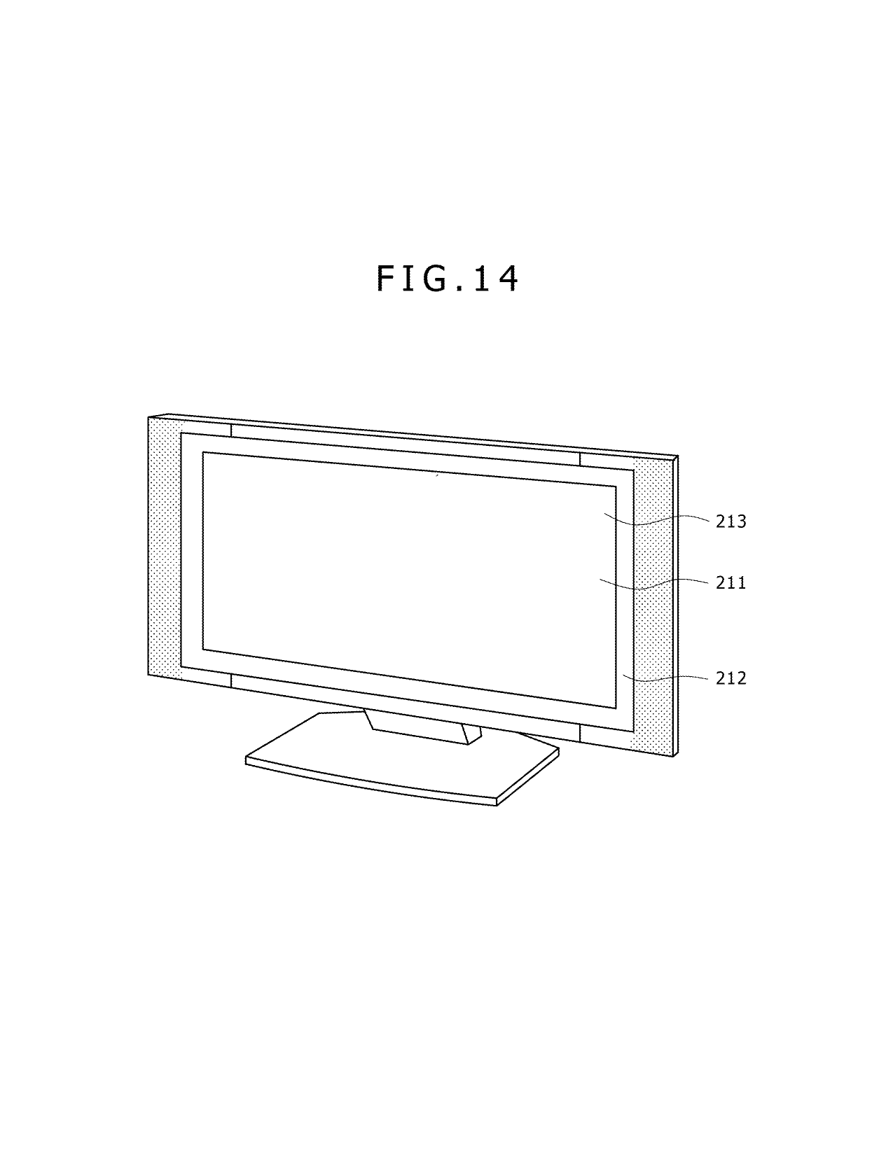

FIG. 14 is a perspective view showing an external appearance of a television set to which the organic EL display device of the embodiment is applied. The television set includes an image display screen 211 having a front panel 212, a filter glass 213, and the like. The television set is manufactured by using the organic EL display device of the embodiment described above in the image display screen 211.

The organic EL display device of the embodiment described above can also be applied to a digital camera. The digital camera includes an imaging lens, a light emitting portion for flush, a display portion, a control switch, a menu switch, a shutter, and the like. The digital camera is manufactured by using the organic EL display device of the embodiment in the display portion.

The organic EL display device of the embodiment described above can also be applied to a notebook-size personal computer. A keyboard which is manipulated when characters or the like are inputted is included in a main body of the notebook-size personal computer. A display portion configured to displaying thereon an image is included in a main body cover. The notebook-size personal computer is manufactured by using the organic EL display device of the embodiment in the display portion.

The organic EL display device of the embodiment described above can also be applied to a personal digital assistance. The personal digital assistance includes an upper chassis, a lower chassis, a coupling portion (for example, a hinge portion), a display portion, a sub-display portion, a picture light, a camera, and the like. The personal digital assistance is manufactured by using the organic EL display device of the embodiment in the display portion and/or the sub-display portion.

The organic EL display device of the embodiment described above can also be applied to a video camera. The video camera includes a main body portion, a lens which captures an image of a subject and which is provided on a side surface directed forward, a start/stop switch which is manipulated when an image of a subject is captured, a monitor, and the like. The video camera is manufactured by using the organic EL display device of the embodiment in the monitor.

### [Recording Medium]

The series of processing described above can be executed either by hardware or by software. When the series of processing is executed by software, a program included in the software is installed in a computer. Here, the computer, for example, includes a computer incorporated in dedicated hardware, and a general-purpose personal computer which can execute various kinds of functions by installing therein various kinds of programs.

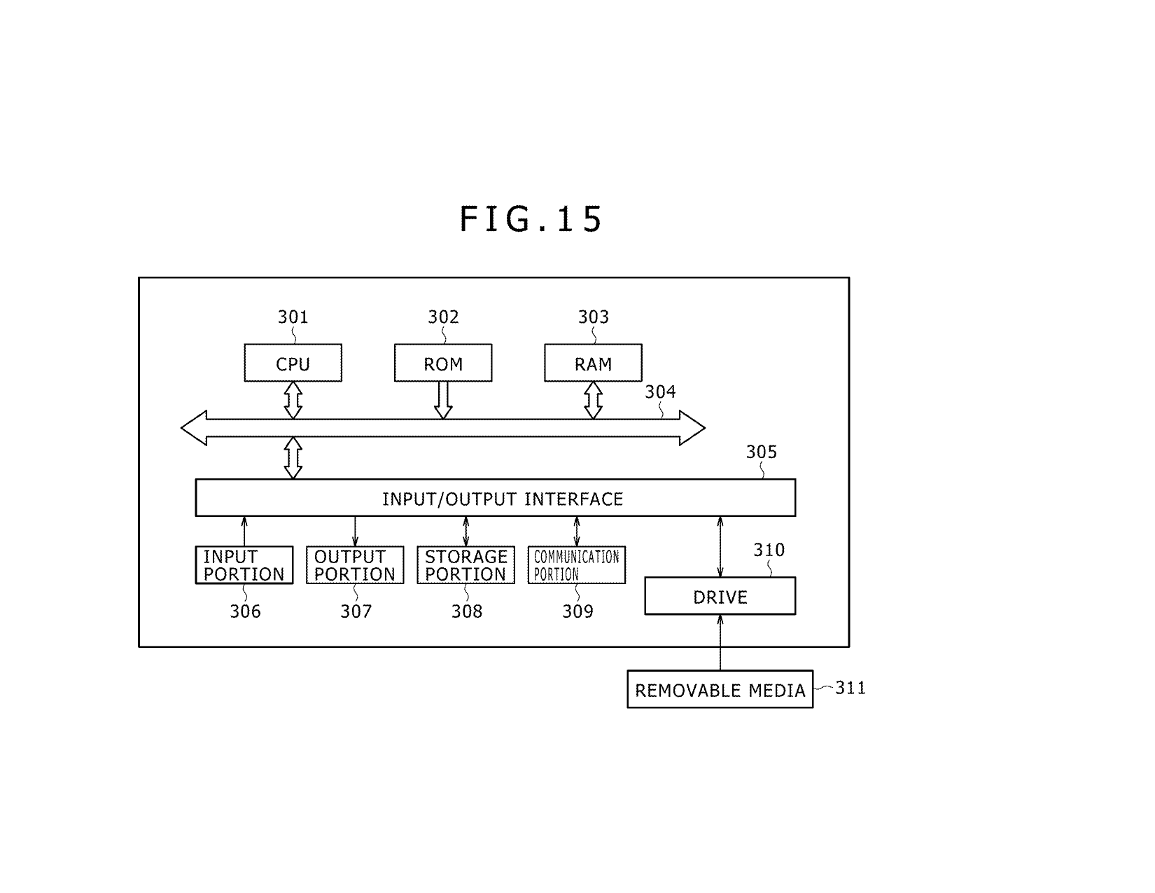

FIG. 15 is a block diagram showing a configuration of hardware of a computer configured to execute the series of processing described above in accordance with a program. In the computer, a central processing unit (CPU) 301, a read only memory (ROM) 302, and a random access memory (RAM) 303 are connected to one another through a bus 304. An input/output interface 305 is further connected to the bus 304. An input portion 306, an output portion 307, a storage portion 308, a communication portion 309, and a drive 310 are connected to the input/output interface 305.

The input portion 306 includes a keyboard, a mouse, a microphone, and the like. The output portion 307 includes a display device, a speaker, and the like. The storage portion 308 includes a hard disc, a non-volatile memory, and the like. The communication portion 309 includes a network interface and the like. The drive 310 drives a removable media 311 such as a magnetic disc, an optical disc, a magneto optical disc, or a semiconductor memory.

With the computer configured in the manner as described above, for example, the CPU 301 loads a program stored in the storage portion 308 into the RAM 303 through the input/output interface 305 and the bus 304 in order to execute the program, thereby executing the series of processing described above.

The program which the computer (the CPU 301) executes, for example, can be recorded in the removable media 311 as a package media or the like to be provided. The program can be provided through a wired or wireless transmission media such as a local area network, the Internet, or a digital satellite broadcasting.

In the computer, the program can be installed in the storage portion 308 through the input/output interface 305 by mounting the removable media 311 to the drive 310. The program can be received at the communication portion 309 through the wired or wireless transmission media to be installed in the storage portion 308. The program can be previously installed either in the ROM 302 or in the storage portion 308.

It is noted that the program which the computer executes either may be a program in accordance with which predetermined pieces of processing are executed in a time series manner along the order described in this specification, or may be a program in accordance with which the predetermined pieces of processing are executed in parallel or at a necessary timing such as when a call is made.

In this specification, a system means an entire apparatus including plural devices or units.

It is noted that the embodiment of the present disclosure are by no means limited to the embodiment described above, and various kinds of changes can be made without departing from the subject matter of the present disclosure.

It is noted that the present disclosure can also adopt following configurations.

(1) A display device including:

a sampling block sampling image data continuously inputted thereto at predetermined intervals;

a gradation value/deterioration amount converting block converting a gradation value of an image based on the image data sampled in the sampling block into a deterioration amount;

a deterioration amount storing block calculating and storing a difference in deterioration amount between a correction object pixel and a reference pixel by using the deterioration amount obtained through the conversion in the gradation value/deterioration amount converting block;

a correction amount calculating block calculating a correction amount required for resolving the deterioration amount difference stored in the deterioration amount storing block based on an estimated deterioration amount within a correction period of time; and

a deterioration amount difference correcting block correcting the gradation value of the corresponding pixel with the correction amount thus calculated.

(2) The display device described in the paragraph (1), in which the sampling block samples the image data at equal intervals.

(3) The display device described in the paragraph (1), in which the sampling block samples the image data at random intervals.

(4) The display device described in the paragraph (1), in which the sampling block divides the area of the image into plural sub-areas, and samples the image data within the sub-areas at equal intervals.

(5) The display device described in the paragraph (1), in which the sampling block divides the area of the image into plural sub-areas, and samples the image data within the sub-areas at random intervals.

(6) The display device described in the paragraph (1), in which the sampling block divides the area of the image into lattice-like sub-areas, and samples the image data within the lattice-like sub-areas at equal or random intervals.

(7) The display device described in the paragraph (1),

in which the deterioration amount storing block includes:
a short-cycle deterioration amount storing block storing therein an accumulated value in units of a short cycle of the deterioration amount generated in increments of the image data sampled;
a deterioration amount difference calculating block calculating a difference in deterioration amount between the correction object pixel and the reference pixel based on the accumulated value; and
a long-cycle deterioration amount storing block storing therein an accumulated value of the deterioration amount difference calculated in increments of a short cycle.

(8) An electronic apparatus including

a display device, the display device having
a sampling block sampling image data continuously inputted thereto at predetermined intervals;
a gradation value/deterioration amount converting block converting a gradation value of an image based on the image data sampled in the sampling block into a deterioration amount;
a deterioration amount storing block calculating and storing a difference in deterioration amount between a correction object pixel and a reference pixel by using the deterioration amount obtained through the conversion in the gradation value/deterioration amount converting block;
a correction amount calculating block calculating a correction amount required for resolving the deterioration amount difference stored in the deterioration amount storing block based on an estimated deterioration amount within a correction period of time; and
a deterioration amount difference correcting block correcting the gradation value of the corresponding pixel with the correction amount thus calculated.

(9) A displaying method including:

sampling image data continuously inputted thereto at predetermined intervals;

converting a gradation value of an image based on the image data sampled into a deterioration amount;

calculating and storing a difference in deterioration amount between a correction object pixel and a reference pixel by using the deterioration amount obtained through the conversion;

calculating a correction amount required for resolving the deterioration amount difference stored based on an estimated deterioration amount within a correction period of time; and

correcting the gradation value of the corresponding pixel with the correction amount thus calculated.

(10) A computer-readable program executing processing including:

sampling image data continuously inputted thereto at predetermined intervals;

converting a gradation value of an image based on the image data sampled into a deterioration amount;

calculating and storing a difference in deterioration amount between a correction object pixel and a reference pixel by using the deterioration amount obtained through the conversion;

calculating a correction amount required for resolving the deterioration amount difference stored based on an estimated deterioration amount within a correction period of time; and

correcting the gradation value of the corresponding pixel with the correction amount thus calculated.

The present disclosure contains subject matter related to that disclosed in Japanese Priority Patent Application JP 2012-002903 filed in the Japan Patent Office on Jan. 11, 2012, the entire content of which is hereby incorporated by reference.

What is claimed is:

1. A display device comprising:
a sampling block sampling image data continuously inputted thereto at predetermined intervals;
a gradation value/deterioration amount converting block converting a gradation value of an image based on the image data sampled in the sampling block into a deterioration amount;
a deterioration amount storing block calculating and accumulating a difference in deterioration amount between a correction object pixel and a reference pixel by using the deterioration amount obtained through the conversion in the gradation value/deterioration amount converting block;
a correction amount calculating block calculating a correction amount required for resolving the deterioration amount difference stored in the deterioration amount storing block based on an estimated deterioration amount within a correction period of time; and
a deterioration amount difference correcting block correcting the gradation value of the corresponding pixel with the correction amount thus calculated.

2. The display device according to claim 1, wherein the sampling block samples the image data at equal intervals.

3. The display device according to claim 1, wherein the sampling block samples the image data at random intervals.

4. The display device according to claim 1, wherein the sampling block divides the area of the image into plural sub-areas, and samples the image data within the sub-areas at equal intervals.

5. The display device according to claim 1, wherein the sampling block divides the area of the image into plural sub-areas, and samples the image data within the sub-areas at random intervals.

6. The display device according to claim 1, wherein the sampling block divides the area of the image into lattice-like sub-areas, and samples the image data within the lattice-like sub-areas at equal or random intervals.

7. The display device according to claim 1,
wherein the deterioration amount storing block includes:
a short-cycle deterioration amount storing block storing therein an accumulated value in units of a short cycle of the deterioration amount generated in increments of the image data sampled;
a deterioration amount difference calculating block calculating a difference in deterioration amount between the correction object pixel and the reference pixel based on the accumulated value; and
a long-cycle deterioration amount storing block storing therein an accumulated value of the deterioration amount difference calculated in increments of a short cycle.

8. An electronic apparatus comprising
a display device, the display device including
a sampling block sampling image data continuously inputted thereto at predetermined intervals;
a gradation value/deterioration amount converting block converting a gradation value of an image based on the image data sampled in the sampling block into a deterioration amount;
a deterioration amount storing block calculating and accumulating a difference in deterioration amount between a correction object pixel and a reference pixel by using the deterioration amount obtained through the conversion in the gradation value/deterioration amount converting block;
a correction amount calculating block calculating a correction amount required for resolving the deterioration amount difference stored in the deterioration amount storing block based on an estimated deterioration amount within a correction period of time; and
a deterioration amount difference correcting block correcting the gradation value of the corresponding pixel with the correction amount thus calculated.

9. A displaying method comprising:
sampling image data continuously inputted thereto at predetermined intervals;
converting a gradation value of an image based on the image data sampled into a deterioration amount;
calculating and storing a difference in deterioration amount between a correction object pixel and a reference pixel by using the deterioration amount obtained through the conversion;
calculating a correction amount required for resolving the deterioration amount difference stored based on an estimated deterioration amount within a correction period of time; and
correcting the gradation value of the corresponding pixel with the correction amount thus calculated.

10. A computer-readable program executing processing comprising:
sampling image data continuously inputted thereto at predetermined intervals;
converting a gradation value of an image based on the image data sampled into a deterioration amount;
calculating and storing a difference in deterioration amount between a correction object pixel and a reference pixel by using the deterioration amount obtained through the conversion;
calculating a correction amount required for resolving the deterioration amount difference stored based on an estimated deterioration amount within a correction period of time; and
correcting the gradation value of the corresponding pixel with the correction amount thus calculated.
